(19) United States
(12) Patent Application Publication
(10) Pub. No.: US 2014/0320061 A1
(43) Pub. Date: Oct. 30, 2014

(54) APPARATUS AND METHOD CONTROLLING SEQUENCINGS FOR MULTIPLE ELECTROLYTE STORAGE TANKS IN A REDUCTION-OXIDATION FLOW BATTERY

(71) Applicant: Ashlawn Energy, LLC, Alexandria, VA (US)

(72) Inventor: Maurice DANIEL, Alexandria, VA (US)

(73) Assignee: Ashlawn Energy, LLC, Alexandria, VA (US)

(21) Appl. No.: 14/265,908

(22) Filed: Apr. 30, 2014

Related U.S. Application Data
(60) Provisional application No. 61/854,714, filed on Apr. 30, 2013.

(51) Int. Cl. H02J 7/00

(52) U.S. Cl. CPC H02J 7/0014
USPC 320/103

(57) ABSTRACT

A flow battery system and method are provided. The flow battery system includes first and second storage tanks initially respectively storing first and second electrolyte and a battery stack that includes a half-cell configured to charge and/or discharge a positive or negative liquid electrolyte provided from the first and second storage tanks. Electrolytes returned from the battery stack are returned with a higher SOC when the selected mode indicates a charging mode and electrolytes are returned from the battery stack with a lower SOC when the selected mode indicates a discharging mode. The flow battery system and method control a defined sequence for a selected mode of one of charging or discharging of the first and second electrolytes to charge or discharge the first electrolyte before charging or discharging the second electrolyte, based on the selected mode.

### CROSS-REFERENCE TO RELATED APPLICATIONS

This application claims the benefit of U.S. Provisional Application No. 61/854,714, filed Apr. 30, 2013, in the United States Patent and Trademark Office, the disclosure of which is incorporated herein by reference.

### BACKGROUND

1. Field

One or more embodiments include a flow battery system and controlling method for charging and/or discharging electrolytes stored in multiple storage tanks and selectively distributed to and from a half cell of a battery stack. More particularly, one or more embodiments include implementing and controlling a defined sequence for the charging and/or discharging of the electrolytes from the multiple storage tanks.

2. Description of the Related Art

Flow batteries represent a system where, when a positive electrolyte is provided to a positive inlet of a battery stack, or battery cell of such a battery stack, and a negative electrolyte is provided to a negative inlet of the battery stack, the flow battery may provide power when the provided positive and negative electrolytes are charged electrolytes and the flow battery may be capable of storing power when the provided positive and negative electrolytes are discharged electrolytes. Accordingly, flow batteries may be ideal for large scale power providing and storing applications. The size of the battery stack(s) within the flow battery may be particularly designed to meet the maximum power requirements of a particular application and the quantity of electrolyte in the storage tanks can be specified to meet the required hours of operation. For example, an all-vanadium redox flow battery could be fabricated using 100 10,000 watt battery stacks to provide the capability of providing a megawatt of electric power. The flow battery could be provided with storage tanks containing 12,500 gallons of 1.56 molar electrolyte, which would give the flow battery sufficient electrolyte to operate for one hour. The flow battery could be increased to provide one megawatt of power for eight hours by simply increasing the amount of electrolyte by eight times, while making no changes to the battery stacks. This design flexibility makes flow batteries ideally suited for storing power for large installations, such as the entire electric output of a wind farm or solar array. In these types of applications the flow battery may be designed to store electric power at the time it is generated by these intermittent sources of power and releasing it to consumers during the times of day when it is needed. Large scale flow batteries also have applications in supplying back-up power, power leveling, grid voltage and/or frequency regulation, spinning reserve, load shifting, and other applications. Flow batteries, and other power storage technologies, are anticipated to become major components of green energy power grids in the near future.

Thus, reduction-oxidation (redox) flow batteries, also known as regenerative fuel cells, or reversible fuel cells, or secondary fuel cells, are a type of storage battery having two liquid electrolytes; a positive electrolyte or catholyte, and a negative electrolyte or anolyte.

The two electrolytes are typically separated from one another by an ion exchange membrane. In this type of battery stack the two electrodes are typically inert and primarily serve to collect or distribute the electric charge from the battery cell(s). The membrane may divide the battery stack, or battery cells of the battery stack, into two half-cells, for example. Here, each half-cell may generally be made up of a rectangular frame with a central rectangular cavity, with the membrane being stretched across one side of the frame and a conductive graphite plate serving as the electrode and extending across the other side of the frame. In such an arrangement, a rectangle of electrically conductive carbon felt may be cut to fit inside and fill the entire cavity of the half-cell to assist in collecting or distributing electric charge from the electrolyte. Positive electrolyte would fill the positive half-cell and negative electrolyte would fill the negative half-cell within the carbon felt. As an example, both electrolytes may include metal salts in an acid solution. For example in an iron/chrome couple redox flow battery the negative electrolyte contains iron ions and the positive electrolyte contains chromium ions, both dissolved in a hydrochloric acid solution. The positive and negative electrolyte solutions are stored in storage tanks external to the battery cell and pumps are typically used to feed the electrolytes through their respective half-cells, of the battery cell, during charging and discharging periods of operation.

Thus, depending on the placement of the storage tanks relative to the battery stacks, in a conventional redox flow battery system the electrolytes may be drawn out of their respective storage tanks by such pumps and injected into the bottom of the battery stack, for example.

FIG. 16 illustrates a conventional two-tank flow battery system during a charging operation. For example, FIG. 16 illustrates a redox flow battery system 1150 with a battery stack 1105 elevated above storage tanks 1101L and 1101R. In this two-tank arrangement, positive electrolyte 1130L is stored in storage tank 1101L and negative electrolyte 1130R is stored in the storage tank 1101R. Electrolyte is respectively drawn out of the bottom of storage tanks 1101L and 1101R by the action of feed pumps 1103L and 1103R. Electrolyte is usually then forced through the bottom of the battery stack 1105 and out the top of the battery stack 1105. After exiting battery stack 1105, the electrolyte respectively flows through pipes 1106L and 1106R into the top of the storage tanks 1101L and 1101R where it is then sprayed, or dripped, onto the top of the electrolyte contained in the storage tank. This spraying of electrolyte into the storage tanks 1101L and 1101R prevents an electrical circuit from being formed in the fluid loop thus reducing shunt current losses. An inert gas 1135, such as nitrogen or argon, may be maintained at the top of the storage tanks 1101L and 1101R to prevent oxidation of the reactants. This example layer of inert gas at the tops of the storage tanks 1101L and 1101R is often referred to as a “blanket”, such as a “nitrogen blanket”. Some sort of snorkel mechanisms 1110L and 1110R may be respectively placed at the top of the storage tanks 1101L and 1101R to allow equalization of the pressure of gas 1135 inside the storage tanks 1101L and 1101R to the ambient air outside the storage tanks 1101L and 1101R.

Again, during charging of the flow battery system 1150, the positive electrolyte 1130L, initially contained in the storage tank 1101L flows out the bottom of the storage tank through pipe line 1102L by the action of the pump 1103L. At this point, available for charging, electrolyte 1130L may initially be considered ‘old discharged’ positive electrolyte, e.g., a positive electrolyte having a state of charge (SOC) of about 20%, also referred to as a 20% SOC. The pump 1103L pushes the old discharged electrolyte through pipe line 1104L and into the bottom of the elevated battery stack 1105. After about three cycles through the battery stack 1105 the previously exhausted (old discharged) positive electrolyte having the state of charge (SOC) of about 20% eventually becomes charged up to about a SOC of 80%, also referred to as an 80% SOC. In each charging cycle, charged electrolyte emerges from the top of the battery stack 1105, where it then flows through line 1106L and into the top of the positive electrolyte storage tank 1101L. The same process may take place on the negative (illustrated right side) of the flow battery, where old discharged negative electrolyte becomes charged negative electrolyte after about three charging cycles through the battery stack 105. As charged electrolyte is returned to storage tanks 1101L and 1101R, the respective electrolytes 130L may be considered a mixture of new charged positive electrolyte being added to old positive electrolyte and the electrolyte 1130R may be considered a mixture of new charged negative electrolyte added to old negative electrolyte.

During a discharging of the flow battery system 1150, the positive electrolyte 1130L, contained in the storage tank 1101L, flows out the bottom of the storage through pipe line 1102L by the action of the pump 1103L. Opposite to the above charging operation, where the positive electrolyte 1130L initially has a SOC of 20%, in the discharging example the positive electrolyte may initially have an SOC of 80%. After about three cycles through the battery stack 1105 the previously charged positive electrolyte having the 80% SOC eventually becomes discharged to about 20% SOC.

The flow battery system 1150 may receive its charge from alternating electric power (AC) taken from the grid, represented as power source 1107, for example. The electric power may be passed through the example rectifiers 1108L and 1108R and into the example two poles, or terminals, 1109L and 1109R of the battery stack 1105. As illustrated, pole 1109L is connected to positive battery half-cells of the battery stack 1105 and pole 1109R is connected to the negative battery half-cells of the battery stack 1105. During normal flow battery charging current flows into the battery pole 1109L and out of the pole 1109R.

As noted above, during a normal charging of discharged electrolyte of the flow battery system 1150, positive electrolyte from the bottom of the left storage tank 1101L is passed through the positive side of an example battery cell of the battery stack 1105, i.e., an example positive half-cell of the battery stack 1105, to become positively charged electrolyte and is then returned to storage tank 1101L. Likewise, on the negative side (illustrated right side) of the flow battery system 1150, depleted negative electrolyte is passed through the negative side of the example battery cell of the battery stack 1105, i.e., an example negative half-cell of the battery stack 1105, to become charged negative electrolyte and is then returned to storage tank 1101R. Similarly, during a discharging of charged negative electrolyte, the negative side of the flow battery system 1150 may cycle the initially charged negative electrolyte through the negative side of the example battery cell of the battery stack1 1105 until the negative electrolyte becomes discharged.

The big advantage of all redox flow batteries is that the electrical energy may be stored entirely in the electrolytes, as opposed to other types of secondary batteries, such as lead-acid car batteries, that store energy on the surface of their electrodes. The power (watts or megawatts) that a flow battery can output may be determined by the amount of surface area of its aforementioned battery cell membranes, which in turn may be a determining factor regarding the overall size of the corresponding battery stack. The amount of power (watt-hours or megawatt-hours) that a flow battery can provide may be determined by its quantity of electrolyte, which typically in turn may determine the size of the storage tanks needed to store the electrolyte. Accordingly, the size of the battery stack(s) of a flow battery system may define the megawatts that the flow battery system can provide and the size of the electrolyte storage tanks of the flow battery system may define the number of hours the flow battery can provide its rated power. This feature of flow batteries allows them to potentially be tailor made to the requirements of a large facility, such as a solar array or wind farm.

Conventionally, there are two configurations of electrolyte storage tanks relative to a particular battery stack. A first configuration may be referred to as a two-tank configuration, where a corresponding first method of cycling electrolyte through the battery stack would be to move electrolyte from a single positive electrolyte storage tank to the battery stack and then back to that positive electrolyte storage tank and to move electrolyte from a single negative electrolyte storage tank to the battery stack and then back to that negative electrolyte storage tank. A second configuration may be referred to as a four-tank configuration, where a corresponding second method of cycling electrolyte through the battery stack would be to move positive electrolyte from a first positive electrolyte storage tank to the battery stack and then back to a second positive electrolyte storage tank, so that a next pass through the battery stack would include the moving of positive electrolyte from the second positive electrolyte storage tank to the battery stack and then back to the first positive electrolyte storage tank. Similarly, the second method of cycling electrolyte through the battery stack would include the moving of negative electrolyte from a first negative electrolyte storage tank to the battery stack and then back to a second negative electrolyte storage tank, so that a next pass through the battery stack would include the moving of negative electrolyte from the second negative electrolyte storage tank to the battery stack and then back to the first negative electrolyte storage tank. Accordingly, the two-tank configuration refers to there being a total of two storage tanks, a first storage tank on the positive side of the battery stack and a second storage tank on the negative side of the battery stack. Similarly, the four-tank configuration refers to there being a total of four storage tanks, first and second storage tanks on the positive side of the battery stack and third and fourth storage tanks on the negative side of the battery stack.

As only an example, a two-tank configuration and the corresponding first method are demonstrated in the above discussed FIG. 16. Again, in this two-tank method the flow battery has one storage tank filled with positive electrolyte and one storage tank filled with negative electrolyte. In this first method, during discharge of the flow battery, charged electrolyte is withdrawn from each storage tank and sent to respective sides of the battery stack where the electrolyte is discharged to yield an electric power output. The spent electrolytes are then returned to their respective storage tanks where they are mixed with the as yet fully charged electrolytes. In this first method the electrolytes become increasingly diluted as power is withdrawn until it becomes too inefficient to extract the remaining power contained in the electrolytes. Calculations performed by NASA researchers in the late 1970's and early 1980's, for example, determined that it may be most efficient to operate such a flow battery when charge/discharge concentrations are between 80% and 20%. For example, during a discharging operation, the flow battery begins at about 80% SOC and is discharged until it reaches about 20% SOC. During the charging portion of the cycle the opposite may be true; the flow battery begins with about 20% SOC and is charged up to about 80% SOC.

When either of the two-tank method or the four-tank methods are scaled up, e.g., so that more battery stacks or banks of battery stacks are available for increased output power, the above noted configurations are merely repeated as needed. For example, with the two-tank configuration/method, a flow battery could have two flow battery strings, the first string would include a positive storage tank, a negative storage tank, and a battery stack or bank of battery stacks, similarly the second string would include another positive storage tank, another negative storage tank, and another battery stack or bank of battery stacks. This can be repeated for a third string of the flow battery, a four string, etc., but each string of the flow battery would still only be configured with the positive and negative storage tanks and an associated battery stack or bank of battery stacks. Likewise, with the four-tank configuration/method, if a different flow battery included two strings, the first string would include two positive storage tanks, two negative storage tanks, and a battery stack or bank of battery stacks, similarly, the second string of this flow battery would include another two positive storage tank, two negative storage tank, and another battery stack or bank of battery stacks. Again, this can be repeated for a third string of the flow battery, a fourth string, etc., but each string of this flow battery would still only be configured with a total of four storage tanks, two positive and two negative storage tanks, and an associated battery stack or bank of battery stacks.

Generally it would be desirable to have the flow battery output a constant amount of power per unit of time. To accomplish this, variable speed pumps may be used that increase the pumping speed as the electrolyte becomes diluted in direct proportion to the amount of reactants in the electrolyte. As an example, if a flow battery began discharging with a pump speed of 10 liters per minute (lpm) and a 80% SOC; then by the time the SOC percentage reached 60% the pumps would be operated at 20 lpm; at 40% SOC the pumps would be operating at 30 lpm; and by the time the SOC percentage reached 20% the pumps would be operating at 40 lpm.

Another important consideration is that generally the electrolyte must pass through the battery stack more than one time before the electrolyte can discharge from 80% SOC to 20% SOC; or before the electrolyte can be charged from 20% SOC to 80% SOC. The number of passes through the battery stack required to charge or discharge the electrolyte to its nominal 80-20% limits varies widely depending on system conditions such as membrane efficiency, electrolyte reactivity rates, temperature, electrolyte concentrations, etc., but generally about three passes through the battery stack may be average. For example, a two-tank flow battery that requires three passes through the battery stack to discharge the electrolyte from 80% SOC to 20% SOC, may require that the total volume of each of the positive and negative electrolytes be run through the battery stack 3.746 times through respective positive and negative half-cells of the battery stack because of the mixing. Thus, more than three times the volume of one storage tank may be required because of the mixing, which occurs in the two-tank method, of charged and discharged electrolyte inside of the respective positive and negative storage tanks of this two-tank configuration.

Differently, as noted above, in the four-tank configuration and method there are two positive tanks and two negative storage tanks, but only one storage tank on each side of the flow battery is initially or finally full with electrolyte. This method begins with one positive storage tank on the positive side of the battery stack and one negative storage tank on the negative side of the battery stack being completely full with charged (or discharged) electrolyte while the other positive storage tank and other negative storage tank are initially empty. Positive and negative electrolyte is then pumped through their respective sides of the battery stack. The depleted (or re-charged) electrolyte is then sent to fill the respective initially empty positive storage tank and initially empty negative storage tank. This process avoids the mixing of discharged electrolyte with the charged electrolyte still in the storage tank, e.g., upon return from the battery stack, which occurs in the two-tank configuration and method.

In the example where three passes are required to charge (or discharge) the electrolyte, during each pass the electrolyte is respectively sent to the initially empty storage tank. The electrolyte is shuffled back and forth between the full and empty storage tanks during each pass until the desired SOC percentage is reached. In the case of a three pass electrolyte being used, only three passes may be required to reach the desired charged (or discharged) condition. The four-tank method may represent a net lowering of pump usage by 20% over the two-tank method. However, the four-tank method may require twice the capital investment in storage tanks and associated plumbing.

In addition, in large flow battery systems the storage tanks typically become unwieldy. For example, a one megawatt/one-hour vanadium redox flow battery (VRFB) using 1.5 molar electrolyte would require 6,250 gallons of positive electrolyte, and an equal amount of negative electrolyte. In order to control the temperature of the electrolyte, it would need to be kept indoors. A reasonable storage tank size would be eight feet high. Therefore the positive electrolyte storage tank would need to be 12 foot in diameter, including an added 10% to house the inert gas blanket at the top of the storage tank. A two-tank vanadium flow battery would require two storage tanks of this size; a four-tank system would require four storage tanks of this size. And this is only for a one-megawatt-hour flow battery; in the future, flow batteries having multiple megawatts for 12 hours or more will be required. These large batteries will require large indoor tank farms of electrolyte storage tanks. The method of efficiently distributing the electrolyte between the storage tanks and the battery stack through a network of plumbing becomes increasingly important in such large flow battery systems.

Another problem that occurs in large flow battery systems with multiple electrolyte storage tanks and several respective battery stacks is that more than one pumping speed may be required simultaneously within the system. This problem occurs because in such a large system several battery stacks may be in use simultaneously, wherein each battery stack may be operating at different SOC percentages. For example this may be done to even out the flow battery operation, wherein one stack is running at a low SOC percentage, another at an intermediate SOC percentage, and a third operating at a highest SOC percentage in a three-pass electrolyte system. As discussed previously, the optimum pumping speed may depend on the SOC percentage of the electrolyte being transited through the respective battery stack. During discharging of the flow battery, a low SOC percentage electrolyte entering the battery stack may require a higher pumping speed than a high SOC percentage electrolyte entering the battery stack. A problem is then created in the electrolyte distribution where some storage tanks are being filled or drained at faster rates than others. If this problem is overlooked, empty or filled storage tanks may not be available when needed as the requirements shift from storage tank to storage tank.

### SUMMARY

One or more embodiments include a flow battery system that includes a first battery stack including a first half-cell configured to charge and/or discharge a positive or negative liquid electrolyte, a first feed system to provide electrolyte to the first battery stack, including at least a first storage tank initially storing a first electrolyte having a first state of charge (SOC) and a second storage tank initially storing a second electrolyte having a second SOC, a first return system to return one of the positive electrolyte or negative liquid electrolyte from the first half-cell of the first battery stack to one of the first storage tank and the second storage tank with a higher SOC during a charging of the first or second electrolytes and with a lower SOC during a discharging of the first or second electrolytes, and a controller to control a defined sequence for a selected mode of one of charging or discharging of the first and second electrolytes, so as to accordingly charge or discharge the first electrolyte before charging or discharging the second electrolyte based on the selected mode.

The first feed system may include a third storage tank that does not store electrolyte at least once during the charging or discharging of the flow battery system.

Here, the controller may control the sequence so as to control the first electrolyte from the first storage tank to be charged or discharged, according to the selected mode, after being returned from the first battery stack to the first storage tank, so as to mix charged first electrolytes existing in the first storage tank with differently charged first electrolytes returned to the first storage tank from the first battery stack.

The controller may control the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

The determined high SOC level may be about 80% SOC and the determined low SOC level may be about 20% SOC.

The determined high SOC level and/or the determined low SOC level may respectively be controlled to change based on a determined number of passes of a full volume of the first or second storage tanks required to transit through the first battery stack to increase the respective first SOC or second SOC to the determined high SOC level or to decrease the respective first SOC or second SOC to the determined low SOC level.

The determined high SOC level and/or the determined low SOC level may respectively be controlled to change based on a determined amount of osmotic water transfer between the first half-cell and another half-cell and/or determined temperature of the first electrolyte and/or the second electrolyte.

The controller may control a first point in time to implement the sequence for controlling the first electrolyte from the first storage tank to be charged or discharged, according to the selected mode, to be different from a second point in time when an other sequence may be implemented to control a first other electrolyte from a first other storage tank in a second flow battery string, different from a first flow battery string that includes at least the first battery stack and the first feed system and the first return system, to be charged or discharged according to the selected mode, so that full charging or full discharging of respective electrolytes from differing storage tanks in the first flow battery string occur at different times than full charging or full discharging of respective electrolytes from differing storage tanks in the second flow battery string.

The controller may control the differing flow rates for the first flow battery string to be selectively different from differing flow rates for the second flow battery string implementing the other sequence.

The controller may control the differing flow rates for the first flow battery string to be selectively different from the differing flow rates for the second flow battery string so that each full charging or full discharging of respective electrolytes stored in all storage tanks in the first flow battery string occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

The controller may control the sequence for a charging or discharging, according to the selected mode, of the first electrolyte between the first storage tank and an empty tank to occur before a charging or discharging, according to the selected mode, of the second electrolyte between the second storage tank and the first storage tank, so that the first electrolyte from the first storage tank having been charged or discharged, according to the selected mode, by the first battery stack is returned to the empty tank and the second electrolyte from the second storage tank having been charged or discharged, according to the selected mode, by the first battery stack is returned to the first storage tank.

The controller may control the sequence so that when the charging or the discharging of the first electrolyte is complete the empty tank becomes full with the first electrolyte after having been fully charged or discharged by the first battery stack and then the second electrolyte stored in the second storage tank is charged or discharged by providing the second electrolyte from the second storage tank to the first battery stack and returned to the first storage tank after having been fully charged or discharged by the first battery stack until the second storage tank is empty and the first storage tank is full of the fully charged or discharged second electrolyte.

The controller may control the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

The determined high SOC level may be about 80% SOC and the determined low SOC level may be about 20% SOC.

The determined high SOC level and/or the determined low SOC level may respectively be controlled to change based on a determined number of passes of a full volume of the first or second storage tanks required to transit through the first battery stack to increase the respective first SOC or second SOC to the determined high SOC level or to decrease the respective first SOC or second SOC to the determined low SOC level.

The determined high SOC level and/or the determined low SOC level may respectively be controlled to change based on a determined amount of osmotic water transfer between the first half-cell and another half-cell and/or determined temperature of the first electrolyte and/or the second electrolyte.

The controller may control a first point in time to implement the sequence for controlling the first electrolyte from the first storage tank to be charged or discharged, according to the selected mode, to be different from a second point in time when an other sequence may be implemented to control a first other electrolyte from a first other storage tank in a second flow battery string, different from a first flow battery string that includes at least the first battery stack and the first feed system and the first return system, to be charged or discharged according to the selected mode, so that full charging or full discharging respective electrolytes from differing storage tanks in the first flow battery string occur at different times than full charging or full discharging of respective electrolyte from differing storage tanks in the second flow battery string.

The controller may control the differing flow rates for the first flow battery string to be selectively different from differing flow rates for the second flow battery string implementing the other sequence.

The controller may control the differing flow rates for the first flow battery string to be selectively different from the differing flow rates for the second flow battery string so that each full charging or full discharging of respective electrolytes stored in all storage tanks in the first flow battery string are scheduled to occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

The controller may control the sequence for a charging or discharging, according to the selected mode, of the first electrolyte between the first storage tank and an empty tank to occur before a charging or discharging, according to the selected mode, of the second electrolyte between the second storage tank and the empty tank, so that the first electrolyte from the first storage tank having been charged or discharged, according to the selected mode, by the first battery stack is initially returned to the empty tank and ultimately returned back to the first storage tank and the second electrolyte from the second storage tank having been charged or discharged, according to the selected mode, by the first battery stack is subsequently initially returned to the empty tank and ultimately returned back to the second storage tank.

The first battery stack including the first half cell, first feed system, and first return system may be all parts of a first flow battery string of the flow battery system that performs a first charging or first discharging, with the flow battery system further including a separate and distinct second flow battery string that includes a second battery stack including a second half-cell configured to charge and/or discharge the positive and negative liquid electrolyte, a second feed system to provide electrolyte to the first battery stack, including at least a third storage tank storing third electrolyte having a third state of charge (SOC) and a fourth storage tank storing fourth electrolyte having a fourth SOC, and a second return system to return one of the positive electrolyte or negative liquid electrolyte from the second half-cell of the second battery stack to one of the third storage tank and the fourth storage tank with a higher SOC during a charging of the third or fourth electrolytes and with a lower SOC during a discharging of the third or fourth electrolytes, wherein the controller controls a defined other sequence for accordingly charging or discharging the third electrolyte before charging or discharging the fourth electrolyte, based on the selected mode.

Here, the controller may control the sequence so that the first electrolyte and the second electrolyte are each provided to the first battery stack with differing flow rates that respectively depend on a determined SOC level of the first SOC and determined SOC level of the second SOC and the controller may control the other sequence so that the third electrolyte and the fourth electrolyte are each provided to the second battery stack with differing flow rates that respectively depend on a determined SOC level of the third SOC and determined SOC level of the fourth SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

The determined high SOC level may be about 80% SOC and the determined low SOC level may be about 20% SOC.

The determined high SOC level and/or the determined low SOC level may be respectively controlled to change for the first flow battery string based on a determined number of passes of a full volume of the first or second storage tanks required to transit through the first battery stack to increase the respective first SOC or second SOC to the determined high SOC level or required to transit through the first battery stack to decrease the respective first SOC or second SOC to the determined low SOC level, and the determined high SOC level and/or the determined low SOC level may be respectively controlled to change for the second flow battery string based on a determined number of passes of a full volume of the third or fourth storage tanks required to transit through the second battery stack to increase the respective third SOC or fourth SOC to the determined high SOC level or required to transit through the second battery stack to decrease the respective third SOC or fourth SOC to the determined low SOC level.

The determined high SOC level and/or the low SOC level for the first flow battery string may be respectively controlled to change based on a determined amount of osmotic water transfer between the first half-cell and another half-cell of the first flow battery string and/or determined temperature of the first electrolyte and/or the second electrolyte, and the determined high SOC level and/or the low SOC level for the second flow battery string may be respectively controlled to change based on a determined amount of osmotic water transfer between the second half-cell and another half-cell of the second flow battery string and/or determined temperature of the third electrolyte and/or the fourth electrolyte.

The controller may control a first point in time to implement the sequence for controlling the first electrolyte from the first storage tank to be charged or discharged, according to the selected mode, to be different from a second point in time when the other sequence is implemented controlling the third electrolyte from the third storage tank, so that full charging or full discharging of differing electrolytes in the first flow battery string occur at different times than full charging or full discharging of differing electrolytes in the second flow battery string.

The controller may control the differing flow rates for the first flow battery string to be selectively different from differing flow rates for the second flow battery string implementing the other sequence.

The controller may control the differing flow rates for the first flow battery string to be selectively different from the differing flow rates for the second flow battery string so that each full charging or full discharging of respective electrolytes stored in all storage tanks in the first flow battery string are scheduled to occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

The controller may control the sequence so as to control the first electrolyte from the first storage tank to be charged or discharged, according to the selected mode, after being returned from the first battery stack to the first storage tank, so as to mix charged first electrolytes existing in the first storage tank with differently charged first electrolytes returned to the first storage tank from the first battery stack, and the controller may control the other sequence so as to control the third electrolyte from the third storage tank to be charged or discharged, according to the selected mode, after being returned from the second battery stack to the third storage tank, so as to mix charged third electrolytes existing in the third storage tank with differently charged third electrolytes returned to the third storage tank from the second battery stack.

The controller may control the sequence for a charging or discharging, according to the selected mode, of the first electrolyte between the first storage tank and an empty tank of the first flow battery string to occur before a charging or discharging, according to the selected mode, of the second electrolyte between the second storage tank and the first storage tank, so that the first electrolyte from the first storage tank having been charged or discharged, according to the selected mode, by the first battery stack is returned to the empty tank and the second electrolyte from the second storage tank having been charged or discharged, according to the selected mode, by the first battery stack is returned to the first storage tank, and the controller may control the other sequence for a charging or discharging, according to the selected mode, of the third electrolyte between the third storage tank and an empty tank of the second flow battery string to occur before a charging or discharging, according to the selected mode, of the fourth electrolyte between the fourth storage tank and the third storage tank, so that the third electrolyte from the third storage tank having been charged or discharged, according to the selected mode, by the second battery stack is returned to the empty tank of the second battery flow string and the fourth electrolyte from the fourth storage tank having been charged or discharged, according to the selected mode, by the second battery stack is returned to the third storage tank.

The controller may control the sequence for a charging or discharging, according to the selected mode, of the first electrolyte between the first storage tank and an empty tank of the first flow battery string to occur before a charging or discharging, according to the selected mode, of the second electrolyte between the second storage tank and the empty tank of the first flow battery string, so that the first electrolyte from the first storage tank having been charged or discharged, according to the selected mode, by the first battery stack is initially returned to the empty tank and ultimately returned back to the first storage tank and the second electrolyte from the second storage tank having been charged or discharged, according to the selected mode, by the first battery stack is subsequently initially returned to the empty tank of the first battery string and ultimately returned back to the second storage tank, and the controller may control the other sequence for a charging or discharging, according to the selected mode, of the third electrolyte between the third storage tank and an empty tank of the second flow battery string to occur before a charging or discharging, according to the selected mode, of the fourth electrolyte between the fourth storage tank and the empty tank of the second flow battery string, so that the third electrolyte from the third storage tank having been charged or discharged, according to the selected mode, by the second battery stack is initially returned to the empty tank of the second flow battery string and ultimately returned back to the third storage tank and the fourth electrolyte from the fourth storage tank having been charged or discharged, according to the selected mode, by the second battery stack is subsequently initially returned to the empty tank of the second flow battery string and ultimately returned back to the fourth storage tank.

The flow battery system may further include one or more pulsation dampers to absorb large changes in controlled flow rates caused by a rapid changing between a high flow rate and a low flow rate upon at least one of: a changing of the selected mode before all electrolytes have been fully charged or discharged; a suspension of a conversion of the first electrolyte, from the first storage tank, from a high SOC to a low SOC and starting of a conversion of the second electrolyte, from the second storage tank, from the high SOC to the low SOC while the conversion of the first electrolyte from the high SOC to the low SOC is suspended, based on the sequence; and a suspension of a conversion of the first electrolyte, from the first storage tank, from the low SOC to the high SOC and starting of a conversion of the second electrolyte, from the second storage tank, from the low SOC to the high SOC while the conversion of the first electrolyte from the low SOC to the high SOC is suspended, based on the sequence.

The first electrolyte, from the first storage tank, may be chosen by the controller for discharging based on a determination that the first electrolyte has a higher initial SOC than the second electrolyte and/or the first electrolyte, from the first storage tank, may be chosen by the controller for charging based on a determination that the first electrolyte has a lower initial SOC than the second electrolyte.

The controller may implement the sequence based upon a predetermined algorithm and an applying of determined factors to the predetermined algorithm, with the determined factors including a measured height of electrolytes in one or more storage tanks on at least one of a positive and negative side of the flow battery system and measured SOC's for electrolytes stored in one or more storage tanks on at least one of the positive and negative side of the flow battery system, so as to modify the schedule for sequencing each charging and/or discharging of electrolytes respectively included in each storage tank on at least one of the positive and negative side of the flow battery system.

The controller may implement a respective positive sequence for a positive side of the flow battery system and implement a negative sequence for a negative side of the flow battery system, and selectively controls the positive sequence to operate differently from the negative sequence.

The flow battery system is a vanadium redox flow battery system.

One or more embodiments include a flow battery control method for controlling a flow battery system having at least a first flow battery string that includes a first storage tank initially storing a first electrolyte with a first state of charge (SOC), a second storage tank initially storing a second electrolyte with a second SOC, and a first battery stack that includes a first half-cell configured to charge and/or discharge a positive or negative liquid electrolyte provided from the first and second storage tanks, the method including controlling a defined sequence for a selected mode of one of charging or discharging of the first and second electrolytes to charge or discharge the first electrolyte before charging or discharging the second electrolyte, based on the selected mode, such that electrolytes returned from the first battery stack are returned with a higher SOC when the selected mode indicates that the first flow battery string is in a charging mode and electrolytes returned from the first battery stack are returned with a lower SOC when the selected mode indicates that the first flow battery string is in a discharging mode.

The method may further include controlling the sequence so as to control the first electrolyte from the first storage tank to be charged or discharged, according to the selected mode, after being returned from the first battery stack to the first storage tank, so as to mix charged first electrolytes existing in the first storage tank with differently charged first electrolytes returned to the first storage tank from the first battery stack.

The method may further include controlling the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

The determined high SOC level may be about 80% SOC and the determined low SOC level may be about 20% SOC.

The method may further include respectively controlling the determined high SOC level and/or the determined low SOC level to change based on a determined number of passes of a full volume of the first or second storage tanks required to transit through the first battery stack to increase the respective first SOC or second SOC to the determined high SOC level or to decrease the respective first SOC or second SOC to the determined low SOC level.

The method may further include respectively controlling the determined high SOC level and/or the determined low SOC level to change based on a determined amount of osmotic water transfer between the first half-cell and another half-cell and/or determined temperature of the first electrolyte and/or the second electrolyte.

The method may further include controlling a first point in time to implement the sequence controlling the first electrolyte from the first storage tank to be charged or discharged, according to the selected mode, to be different from a second point in time when an other sequence is implemented controlling a first other electrolyte from a first other storage tank in a second flow battery string, different from the first flow battery string, to be charged or discharged according to the selected mode, so that full charging or full discharging of respective electrolytes from differing storage tanks in the first flow battery string occur at different times than full charging or full discharging of respective electrolytes from differing storage tanks in the second flow battery string.

The method may further include controlling the differing flow rates for the first flow battery string to be selectively different from differing flow rates for the second flow battery string implementing the other sequence.

The method may further include controlling the differing flow rates for the first flow battery string to be selectively different from the differing flow rates for the second flow battery string so that each full charging or full discharging of respective electrolytes stored in all storage tanks in the first flow battery string occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

The method may further include controlling the sequence for a charging or discharging, according to the selected mode, of the first electrolyte between the first storage tank and an empty tank to occur before a charging or discharging, according to the selected mode, of the second electrolyte between the second storage tank and the first storage tank, so that the first electrolyte from the first storage tank having been charged or discharged, according to the selected mode, by the first battery stack is returned to the empty tank and the second electrolyte from the second storage tank having been charged or discharged, according to the selected mode, by the first battery stack is returned to the first storage tank.

The method may further include controlling the sequence so that when the charging or the discharging of the first electrolyte is complete the empty tank becomes full with the first electrolyte after having been fully charged or discharged by the first battery stack and then the second electrolyte stored in the second storage tank is charged or discharged by providing the second electrolyte from the second storage tank to the first battery stack and returned to the first storage tank after having been fully charged or discharged by the first battery stack until the second storage tank is empty and the first storage tank is full of the fully charged or discharged second electrolyte.

The method may further include controlling the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

The determined high SOC level may be about 80% SOC and the determined low SOC level may be about 20% SOC.

The method may further include respectively controlling the determined high SOC level and/or the determined low SOC level to change based on a determined number of passes of a full volume of the first or second storage tanks required to transit through the first battery stack to increase the respective first SOC or second SOC to the determined high SOC level or to decrease the respective first SOC or second SOC to the determined low SOC level.

The method may further include respectively controlling the determined high SOC level and/or the determined low SOC level to change based on a determined amount of osmotic water transfer between the first half-cell and another half-cell and/or determined temperature of the first electrolyte and/or the second electrolyte.

The method may further include controlling a first point in time to implement the sequence for controlling the first electrolyte from the first storage tank to be charged or discharged, according to the selected mode, to be different from a second point in time when an other sequence is implemented controlling a first other electrolyte from a first other storage tank in a second flow battery string, different from the first flow battery string, to be charged or discharged according to the selected mode, so that full charging or full discharging respective electrolytes from differing storage tanks in the first flow battery string occur at different times than full charging or full discharging of respective electrolyte from differing storage tanks in the second flow battery string.

The method may further include controlling the differing flow rates for the first flow battery string to be selectively different from differing flow rates for the second flow battery string implementing the other sequence.

The method may further include controlling the differing flow rates for the first flow battery string to be selectively different from the differing flow rates for the second flow battery string so that each full charging or full discharging of respective electrolytes stored in all storage tanks in the first flow battery string are scheduled to occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

The method may further include controlling the sequence for a charging or discharging, according to the selected mode, of the first electrolyte between the first storage tank and an empty tank to occur before a charging or discharging, according to the selected mode, of the second electrolyte between the second storage tank and the empty tank, so that the first electrolyte from the first storage tank having been charged or discharged, according to the selected mode, by the first battery stack is initially returned to the empty tank and ultimately returned back to the first storage tank and the second electrolyte from the second storage tank having been charged or discharged, according to the selected mode, by the first battery stack is subsequently initially returned to the empty tank and ultimately returned back to the second storage tank.

The method may further include, using one or more pulsation dampers in the first flow battery string, absorbing large changes in controlled flow rates caused by a rapid changing between a high flow rate and a low flow rate upon at least one of: a changing of the selected mode before all electrolytes have been fully charged or discharged; a suspension of a conversion of the first electrolyte, from the first storage tank, from a high SOC to a low SOC and starting of a conversion of the second electrolyte, from the second storage tank, from the high SOC to the low SOC while the conversion of the first electrolyte from the high SOC to the low SOC is suspended, based on the sequence; and a suspension of a conversion of the first electrolyte, from the first storage tank, from the low SOC to the high SOC and starting of a conversion of the second electrolyte, from the second storage tank, from the low SOC to the high SOC while the conversion of the first electrolyte from the low SOC to the high SOC is suspended, based on the sequence.

The method may further include choosing the first electrolyte, from the first storage tank, for discharging based on a determination that the first electrolyte has a higher initial SOC than the second electrolyte and/or choosing the first electrolyte, from the first storage tank, for charging based on a determination that the first electrolyte has a lower initial SOC than the second electrolyte.

The method may further include respectively implementing the sequence based upon a predetermined algorithm and applying determined factors to the predetermined algorithm, with the determined factors including a measured height of electrolytes in one or more storage tanks on at least one of a positive and negative side of the flow battery system and measured SOC's for electrolytes stored in one or more storage tanks on at least one of the positive and negative side of the flow battery system, so as to modify the schedule for sequencing each charging and/or discharging of electrolytes respectively included in each storage tank on at least one of the positive and negative side of the flow battery system.

The method may further include implementing a respective positive sequence for a positive side of the flow battery system and implementing a negative sequence for a negative side of the flow battery system, and selectively controlling the positive sequence to operate differently from the negative sequence.

The flow battery system in such a method may be a vanadium redox flow battery system.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a full-tank multi-tank flow battery system and method, according to one or more embodiments;

FIG. 2 illustrates an empty-tank multi-tank flow battery system and method, according to one or more embodiments;

FIG. 3 is a Gantt chart of an empty-tank modified round-robin three-pass electrolyte distribution approach using two side-by-side tank farms, according to one or more embodiments;

FIG. 4 is a Gantt chart of an empty-tank modified round-robin three-pass electrolyte distribution approach using two side-by-side tank farms having staggered timing between the two tank farms, according to one or more embodiments;

FIG. 5 is a Gantt chart of an empty-tank modified round-robin three-pass electrolyte distribution approach using two side-by-side tank farms having staggered timing between the two tank farms with start-up adjustments, according to one or more embodiments;

FIG. 6 is a chart of a voltage output proportional to SOC consumption of an empty-tank modified round-robin three-pass electrolyte distribution approach using two side-by-side tank farms, according to one or more embodiments;

FIG. 7 is a chart of a voltage output proportional to SOC consumption of an empty-tank modified round-robin three-pass electrolyte distribution approach using two side-by-side tank farms having staggered timing between the two tank farms, according to one or more embodiments;

FIG. 8 is a chart of a voltage output proportional to SOC consumption of a modified empty-tank round-robin three-pass electrolyte distribution approach using two side-by-side tank farms having staggered timing between the two tank farms with start-up adjustments, according to one or more embodiments;

FIG. 9 illustrates a flow battery system including a storage tank management controller system, according to one or more embodiments;

FIGS. 10-14 are respective charts representing calculated example states of charge (SOC) relative respective flow volumes of 1 through 5 passes of electrolyte through a battery stack during a charging operation, according to one or more embodiments;

FIG. 15 is a chart representing calculated example respective efficiencies of a flow battery system relative to the number of electrolyte passes through a battery stack that may be needed for a charging operation, according to one or more embodiments; and

FIG. 16 illustrates a conventional two-tank flow battery system during a battery charging operation.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

One or more embodiments relate to flow batteries, such as Reduction-Oxidation (Redox) Flow Batteries, also known as regenerative fuel cells, or reversible fuel cells, or secondary fuel cells. Further, one or more embodiments may relate to flow batteries having multiple positive and negative electrolyte storage tanks and innovative approaches for distributing electrolyte between such multitude of storage tanks and one or more battery stacks. In one or more embodiments, apparatuses and/or methods take into account simultaneously running pumps at different speeds and storing corresponding respective electrolytes having several different States of Charge (SOC) in several different storage tanks. One or more embodiments include novel approaches for tailoring techniques described herein to achieve a more uniform and efficient electrolyte distribution to or from the battery stacks, and/or for maintaining a more uniform voltage output during the switching between storage tanks. In one or more embodiments, approaches for controlling the distribution of electrolytes between strings of multiple storage tanks and respective battery stacks are also provided. Herein, a “tank farm” is a term meaning a string multiple storage tanks configured to store positive and/or negative electrolytes for provision to at least one particular battery stack or battery bank of a plurality of battery stacks, or multiple separate strings of such storage tanks configured to respectively store positive and/or negative electrolytes for provision to a respective one or more particular battery stacks or battery banks.

Though not limited thereto, storage tanks herein may generally have top and bottom portions, where electrolyte returned from a battery stack to a storage tank may enter at the top portion of the storage tank and where electrolyte may exit toward the battery stack from the bottom portion of the storage tank. The top of the storage tank may generally be filled with an inert gas, such as nitrogen or argon, to keep some of the reactants from oxidizing. The layer of inert gas at the tops of the storage tanks is often referred to as a “blanket”, such as a “nitrogen blanket”. The electrolyte may be sprayed or dripped into the storage tank from above the top surface of the electrolyte. This may be done in order to prevent a “shunt current” flow of electricity from flowing through the storage tank of electrolyte and contributing to parasitic shunt current losses. The tops of one or more the storage tanks may also include a collection of devices, which may collectively be referred to as a “snorkel”. The snorkel may serve to equalize pressure in one or more storage tanks with an outside atmosphere, for example, while also helping to prevent atmospheric oxygen from coming in contact with an electrolyte inside the storage tank, e.g., to avoid oxidation of the electrolyte. A snorkel may also be configured to allow accumulated hydrogen gas and/or oxygen gas to escape from inside the battery stack; help to maintain electrolyte(s) in one or more storage tanks at a desired temperature; prevent contaminants from entering such storage tanks; and other applications as appropriate.

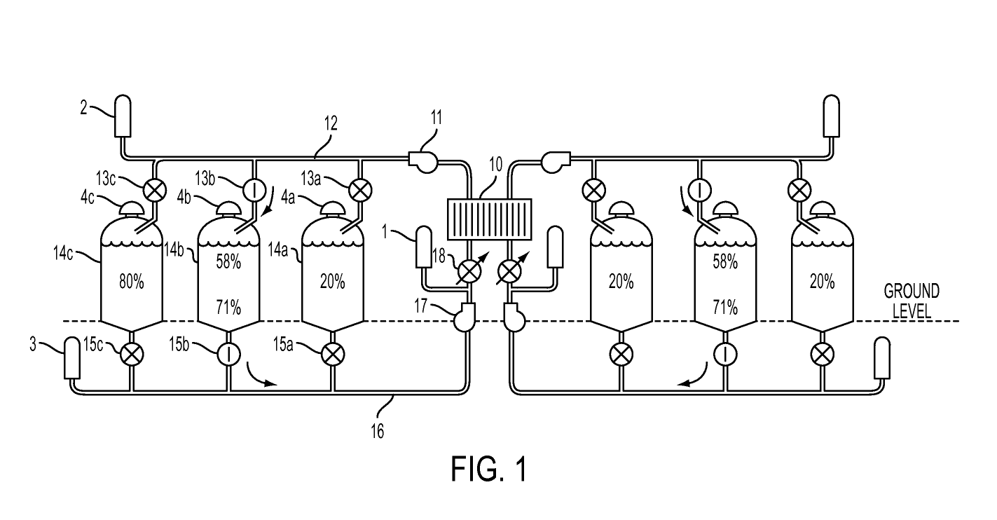

The bottom of the storage tanks are pictured in FIGS. 1-2 and 9, for example, as having a funnel shape leading to an output line, e.g., at a bottom portion of the storage tank. Other configurations are possible whereby an output line pulls electrolyte from the lowest point inside the storage tank, e.g., using a pump. This approach may prevent the possible buildup of particulates and impurities at the bottom of the storage tank. In one or more embodiments, a filtering device may be installed elsewhere at some convenient place in the plumbing, e.g., at a convenient access point, to control the existence of such participants and impurities. If the storage tanks are large, their bottoms may be resting on the ground; or slightly below ground level within a containment structure to prevent accidental spills from contaminating the environment. Within a building the ground level may be the floor level, for example. In one or more embodiments, the storage tanks may also be elevated above or placed below such a ground or floor level.

For large electrolyte tank farms having a total of more than the two or four electrolyte storage tanks discussed with regard to conventional configurations and methods, such conventional two- or four-tank electrolyte distribution methods cannot explain how to control the flow of electrolyte when there are a string of storage tanks on each side of a battery stack, for example.

For example, one or more embodiments may be directed to flow battery configurations that include two or more positive and two or more negative storage tanks, where a conventional two-tank electrolyte distribution method cannot explain how to handle the extra storage tanks. Similarly, one or more embodiments may be directed to flow battery configurations that include three or more positive and two or more negative storage tanks, where a conventional four-tank electrolyte distribution method cannot explain how to handle the additional storage tanks.

Accordingly, in one or more embodiments, one or more variations of a “full-tank” approach may be applied for a string of storage tanks including at least more than the number of storage tanks used in the two-tank electrolyte distribution method. Likewise, in one or more embodiments, one or more variations of an “empty-tank” approach may be applied for a string of storage tanks including at least more than the number of storage tanks used in the four-tank electrolyte distribution method.

Such multiple storage tank configurations are generally large flow battery systems involving the storage of thousands of gallons of electrolyte. As noted above, an entire collection of multiple positive and negative storage tanks that feed into a particular battery bank, or particular battery stack, may be referred to as a “string” of storage tanks.

Briefly, as only an example, herein a “battery stack” may refer to a collection of “battery cells”, e.g., bolted together in the shape of a rectangular volume. Each battery cell may include a positive and negative “half cell” on either side of a membrane of that battery cell, for example. As only an example, in one or more embodiments, each half cell volume may be sandwiched between the respective membrane on one side and a bipolar graphite electrode on the other side and surrounded by a plastic frame. The half cells may be filled with a graphite or carbon felt. Manifolds may also be incorporated into the frames to distribute positive and negative electrolyte into and out of each cell in the battery stack. In one or more embodiments, the battery stacks may be designed to output from one to thirty kilowatts of electric power and may occupy from a cubic foot to a cubic meter in volume. The “string” of battery stacks may be mounted along a linear metal shelf or other supporting structure and wired together in series to provide several hundred volts or more of electric power output. As another example, a number of strings of battery stacks may be mounted together in adjacent racks, both above and besides one another, as only an example, to form a “battery bank”. The strings of battery stacks within a battery bank may be wired together in parallel and sent to an “inverter”, included in the flow battery, which converts the electric power to alternating current (AC) and sends it to the grid or other electric load. Though particular configurations of such battery stacks or collection of battery stacks and battery bank have been described, it is noted that such references are only examples, as alternative configurations are also available, e.g., depending on the need or desire for particular applications.

As only an example, in one or more embodiments, large systems having more than one string of storage tanks in a tank farm, for example, may average the output of one storage tank string and an associated battery bank together with the output of one or more additional storage tank strings and their associated battery banks, e.g., in order to achieve a more uniform power output over time.

Returning to example electrolyte distribution approaches described herein, the aforementioned conventional two-tank method, where each of a positive electrolyte side and a negative electrolyte side of a flow battery are charged and discharged by returning electrolyte to the storage tank from which the electrolyte was provided to the battery stack, cannot explain how to handle for a system including a string of storage tanks. Rather, in such an arrangement, a full-tank approach according to one or more embodiments may be implemented based on a particular sequencing rotation between storage tanks. In such a particular sequencing, respective electrolyte taken from one of the positive and one of the negative storage tanks is sent through the battery stack, where it is charged or discharged, and is then returned to their originating storage tanks, and another storage tank is used based on the particular sequencing. For a more uniform charging or discharging, the particular sequencing may also include the pump speed being increased when the SOC percentage is low and decreased when the SOC percentage is high, and/or where differing strings of the flow battery are sequentially operated differently. The electrolyte circulates in this fashion for as many passes as necessary to charge or discharge the electrolyte between the example 80/20 SOC limits, e.g., 80% SOC for charged electrolyte and 20% for discharged electrolyte. Once the desired SOC percentage is reached the next available set of positive and negative storage tanks in the tank farm are caused to provide their respective electrolytes to the battery stack.

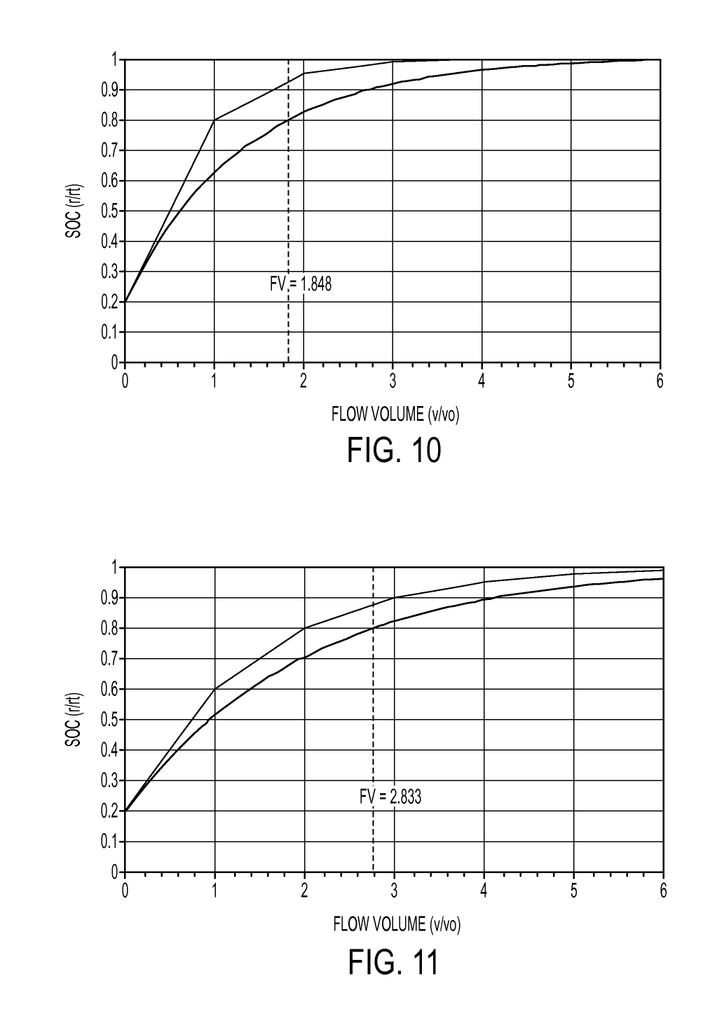

In this full-tank approach, charged and discharged electrolyte is continuously being mixed together within a respective storage tank so that some of the already processed electrolyte is returned to the battery stack and re-processed; giving this approach a built-in inefficiency. However, in one or more embodiments, because electrolytes are added to the top of the storage tank and withdrawn from the bottom, and no intentional mixing occurs within the respective storage tank, this inefficiency may be minimized in practice. However, for the purpose of the calculations presented in FIGS. 10-15, it will be assumed that corresponding complete mixing of the electrolyte continually takes place within the storage tanks.

Similarly, the aforementioned conventional four-tank approach, where each of a positive electrolyte side and a negative electrolyte side of a flow battery are charged and discharged by providing electrolyte from a first storage tank to a battery stack and returning electrolyte from the battery stack to a second storage tank until all electrolyte from the first storage tank traverses the battery stack and is returned to the second storage tank, cannot explain how to handle a system including a string of storage tanks that is greater than two on each side of the example battery stack. Rather, in such an arrangement, an empty-tank approach according to one or more embodiments may be implemented based on another particular sequencing between storage tanks. Using the positive side of the flow battery as an example, in such a particular sequencing, respective electrolyte taken from a first storage tank is sent through the battery stack, where it is charged or discharged, and is then returned to a second, potentially empty, storage tank. When the entire contents of the first storage tank traverses the battery stack and is returned to the second storage tank, the process is reversed and electrolyte is sent to the battery stack from the second storage tank to be returned to the first storage tank. For example, a first pass through the battery stack may discharge the 80% SOC electrolyte (initially in the first storage tank) to 50% SOC when returned to the second storage tank, and further reduce the now 50% SOC electrolyte in the second storage tank to 32% SOC when returned to the first storage tank, and the next pass eventually returns 20% SOC electrolyte to the second storage tank. When this electrolyte becomes 20% SOC, for example, the process may then proceed to a next available storage tank, for example, that initially includes 80% SOC electrolyte and use the now ‘empty’ first storage tank for discharging the new storage tank's 80% SOC electrolyte to 20% SOC through another example three passes. Thus, the electrolyte circulates in this fashion for as many passes as necessary to charge or discharge the electrolyte between the example 80/20 SOC limits, e.g., 80% SOC for charged electrolyte and 20% for discharged electrolyte. Similar to above, for a more uniform charging or discharging, another particular sequencing may also include the pump speed being increased when the SOC percentage is low and decreased when the SOC percentage is high.

Here, this particular sequencing can be based on a conventional round-robin scheduling implemented for computer processes, e.g., in the computer industries and standard computer procedures, that includes assigning time slices to each process in equal portions and in circular order, handling all processes without priority. Thus, if such a ‘round-robin’ sequencing is now applied to the full-tank configuration of a string of storage tanks the contents of each storage tank would be passed through the battery stack with the same amount of time until the respective storage tank is charged from 20% SOC to 80% SOC. If such a ‘round-robin’ sequencing is now applied to the empty-tank configuration of a string of storage tanks the contents of each sequential overlapping pair of storage tanks in the string of storage tanks would be used to eventually charge the electrolyte from one of the paired storage tanks from 20% SOC to 80% SOC, e.g., with each sequence of using paired overlapping storage tanks of the string of storage tanks being done within a same amount of time. Similarly, if such a ‘round-robin’ sequencing is now applied to different strings of the flow battery, e.g., respectively different strings of storage tanks each associated with a particular battery stack or battery bank of plural battery stacks, then each sequencing of each flow battery string, using either a full-tank approach or an empty-tank approach, would also occur in a particular order at the same times. Briefly, as discussed in more detail below, these round-robin full- and empty-tank approaches and modified round-robin full- and empty-tank sequences are also demonstrated in at least FIGS. 1-9 and discussed throughout this disclosure, according to differing embodiments.

For both an example full-tank configuration for a string of storage tanks and an example empty-tank configuration for a string of storage tanks a respective amount of electrolyte that may need to be pumped through an example battery stack has now been calculated for a change from a 20% SOC electrolyte to an 80% SOC, as represented in FIGS. 10-15, calculated for both the full-tank approach (with complete mixing) and the empty-tank approach.

Thus, in FIGS. 10-14, the SOC percentage is plotted as a function of the flow volume passing through the example battery stack. If the pump speed is maintained constant regardless of the SOC percentage of the electrolyte being moved toward the example battery stack, then the flow volume of electrolyte moving through the system is proportional to the time required to charge the flow battery, for example. This may also represent an equal amount of time being used to move electrolyte from each storage tank to the corresponding battery stack or battery bank independent of the SOC percentage of the electrolyte being moved toward the example battery stack. The performance of interest is between 20% and 80% SOC, but the curves shown in FIGS. 10-14 have also been plotted for values beyond 80% to better understand the system behavior. These example curves of FIGS. 10-14 are dependent on the number of passes the electrolyte must make through the battery stack to reach the 80% SOC and provide glimpses into the efficiencies and desirability of each of the full-tank and the empty-tank approaches.

FIG. 10 illustrates a system performance for a flow battery that only requires one pass of a 20% SOC electrolyte through the battery stack to reach 80% SOC. In this example, the empty-tank approach (upper segmented curve) produces a linear performance up to the point where one storage tank volume of positive and negative electrolyte has passed through the battery stack. The full-tank approach (with complete mixing) produces an exponential performance curve (bottom curve) that does not reach 80% SOC until 1.848 storage tank volumes of electrolyte have been pumped through the battery stacks. Therefore, in this example the full-tank approach may require almost twice the pumping energy and almost twice the time to charge up one pair of electrolyte storage tanks compared to the empty-tank approach.

FIG. 11 illustrates performance curves for the empty-tank approach (upper segmented curve) and full-tank approach (lower exponential curve) when two passes are required to charge a 20% SOC electrolyte to 80% SOC. The charging process within the battery stack is more efficient when the SOC percentage is lower for electrolyte entering the battery stack. Thus the slope of the empty-tank approach falls off for the second segment (between 60% and 80% SOC). Using two-pass electrolyte requires the pumps to move exactly two storage tank volumes through the battery stacks; while the full-tank approach requires that 2.833 storage tank volumes of electrolyte be passed through the battery stack. The amount of extra electrolyte that needs to be passed through the system using the full-tank approach on a two-pass electrolyte is only slightly less than the empty-pass approach; i.e. 0.833 verses 0.848. However, as a percentage of the entire required flow, the difference drops dramatically from 45.9% of the total added pumping volume (or time) to 29.4% of the added pumping time.

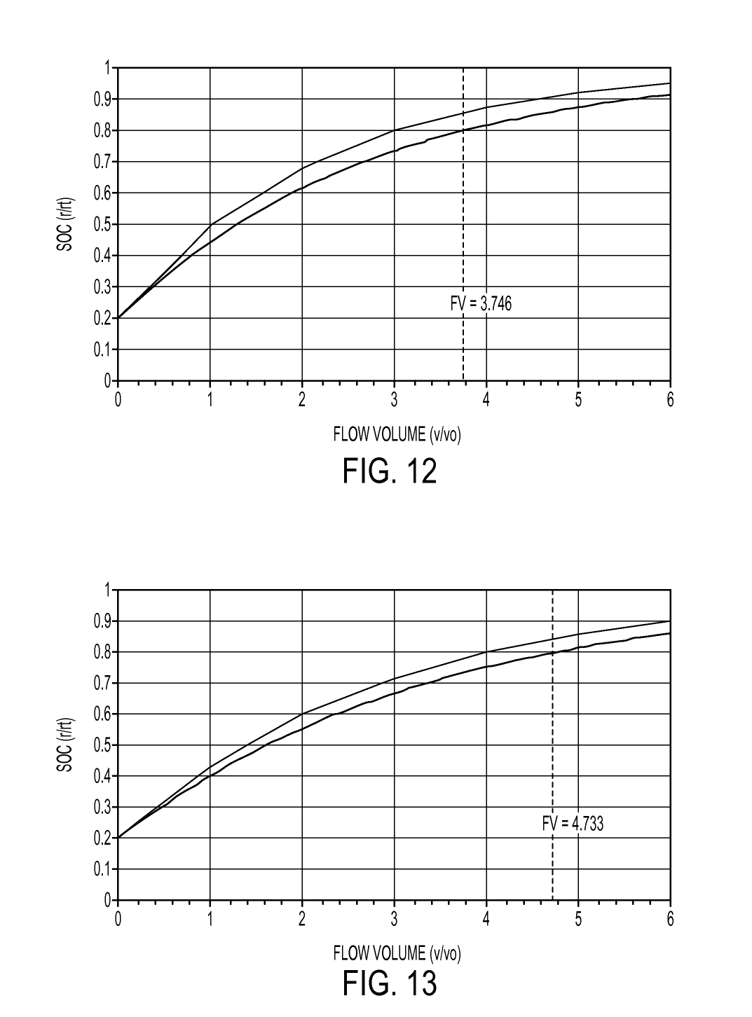

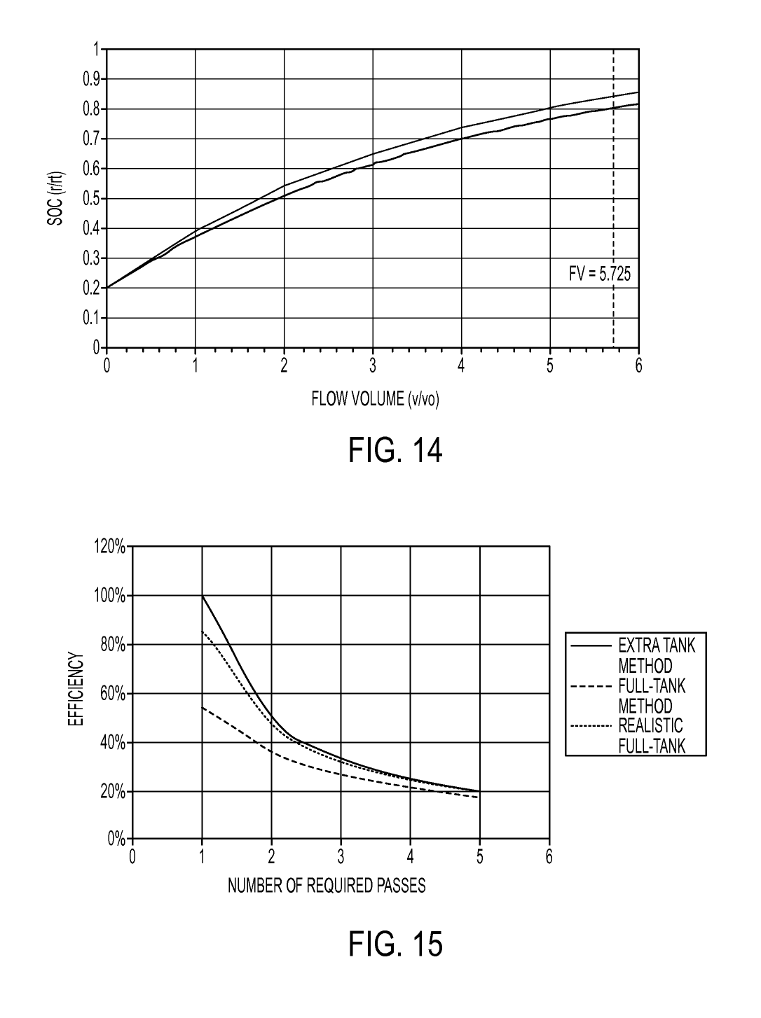

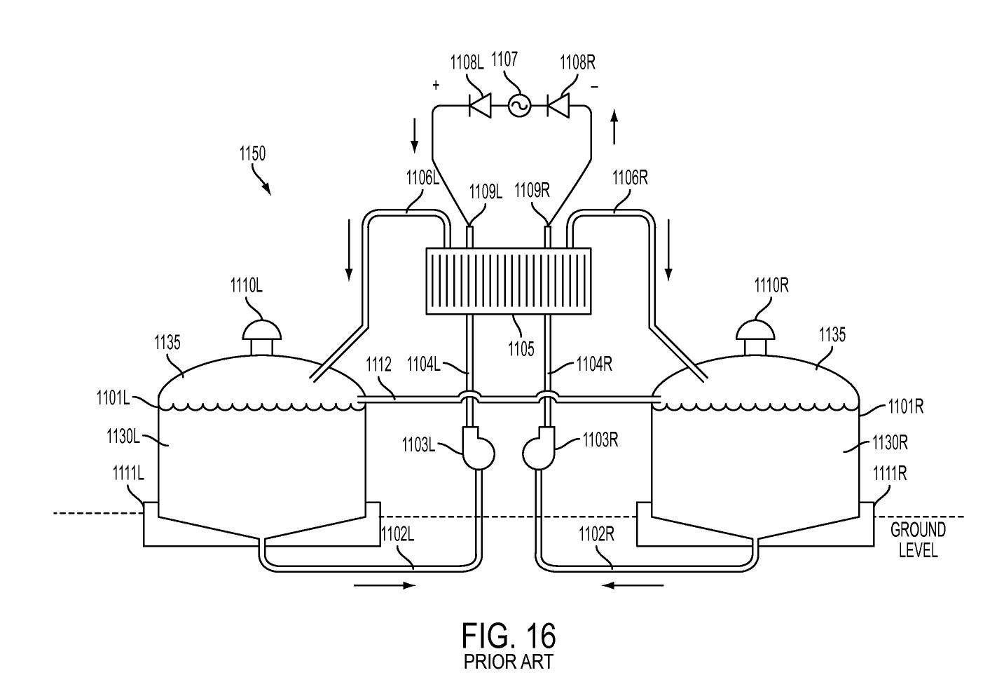

FIGS. 12-14 illustrate plots of performance curves for systems that require the 20% SOC electrolyte to respectively make 3, 4, and 5 passes through the battery stack to reach 80% SOC. The curves for the extra-tank approach and the full-tank approach are seen to become closer together and almost merge as the required number of passes increases. The difference in terms of units of flow volumes between the two curves drops to 0.725 in FIG. 14, or only 12.6% of the total flow volume in FIG. 14. The efficiencies of the charts shown in FIGS. 10-14 are summarized in the chart illustrated in FIG. 15. FIG. 15 is a chart representing calculated example respective efficiencies of a flow battery system relative to the number of electrolyte passes through a battery stack during a charging operation, according to one or more embodiments.

Thus, as only an example summary of the illustrated results of FIGS. 10-14, FIG. 15 illustrates respective plots, where the flow is considered to be 100% efficient if the electrolyte can be converted from 20% SOC to 80% SOC by passing one storage tank volume through the battery stack. Against this criterion, each added pass through the battery stack significantly reduces the flow battery efficiency. The full-tank approach (bottom curve) with its added pumping requirements shows up as a significant drop in efficiency in the illustrated curves of FIG. 15. However, as the number of required passes increases the comparative efficiency between the two approaches converge.

As mentioned previously, the full-tank approach may generally not involve a complete mixing of the reacted electrolyte with the un-reacted electrolyte. An actual performance curve for a full-tank approach would be somewhere between the empty-tank approach and full-tank approach. Without using special storage tank designs to minimize mixing between electrolyte returning from the battery stack and the electrolyte being forwarded to the battery stack, there could be an assumption that there would only be about a 20% real-world mixing of such electrolytes for the full-tank approach using the example storage tank design described herein, e.g., with electrolyte being withdrawn from the storage tank in a lower portion of the storage tank and electrolyte being returned to the storage tank in an upper portion of the storage tank. The dashed curve in FIG. 15 illustrates this likely ‘realistic’ real world mixing scenario.

In a three pass flow battery system, the chart shown in FIG. 15 shows that a pump loss efficiency would be an example 33.3% for the empty-tank approach, 26.7% for the full-tank approach with complete mixing, and 31.8% for the realistic full-tank approach. Therefore as an engineering estimate, a typical flow battery with three-pass electrolyte, may suffer about a 1.58% loss in over-all pumping efficiency using a realistic full-tank approach. Although this loss seems small, it extends over the life of the flow battery, for perhaps 20 years or more. Secondly, using this same realistic model, the over-all flow battery cycle time is increased by approximately 5%, which represents a second loss in performance caused by using the full-tank design method.

Again, as noted above, one or more embodiments set forth round-robin approaches, including modified round-robin approaches, for distributing electrolyte between multiple storage tanks and a battery stack(s) or bank(s) of battery stacks. Accordingly, in one or more embodiments, a plumbing distribution network may be provided to accommodate multiple passes of electrolyte through the battery stacks and associated storage of electrolytes at various SOC percentages. One or more embodiments set forth a flow battery storage approach that allows several electrolyte flow rates to occur simultaneously in the plumbing between said storage tanks and said battery stacks. One or more embodiments includes providing a substantially uniform flow battery power output, or power input, as the electrolyte in the flow battery is charged or discharged in a multiple storage tank system having various SOC percentages and flow rates. Still further, one or more embodiments set forth an electrolyte distribution approach in a large flow battery having multiple electrolyte storage tanks and having several battery banks operating at different SOC percentages and different flow rates including a possibility of simultaneously charging and discharging different portions of the battery banks. In addition, one or more embodiments provide an approach for minimizing flow battery voltage variations due to the switching of electrolyte flow between storage tanks having different SOC percentages.

FIGS. 1, 2, and 9 depict various configurations of multi-tank redox flow battery systems. The systems described here are generally symmetric between the two sides of the flow battery, i.e., the positive side of a corresponding battery stack. Briefly, though FIGS. 1, 2, and 9 explain the described systems and methods according to one or more embodiments with only limited example components, the embodiments are not limited to the same. Rather, several or many additional components and features may be included, such as drainage valves, safety and pressure relief valves, heat exchangers, and other components and sensors that may make up a redox flow battery.

FIG. 1 illustrates a full-tank multi-tank flow battery system and method, according to one or more embodiments. In this particular example three storage tanks are shown on each side of the battery stack 10. Briefly, in or more embodiments, battery stacks 10, 20, and 90 in respective FIGS. 1, 2, and 9 may also be symbolically representative of an entire battery bank which may contain one or more strings of battery stacks. For this discussion of FIG. 1, it may be assumed the storage tanks and components on the positive side (illustrated left side of FIG. 1) of the flow battery of FIG. 1, of the battery stack 10 contain positively charge electrolyte and storage tanks on the negative side (illustrated right side) of the battery stack 10 contain negatively charge electrolyte. Currently charged or discharged electrolyte may be drawn from battery stack 10 by pump 11, for example, so as to be provided along pipe-line 12 and returned into any of the positive storage tanks 14a, 14b, or 14c, depending on the respective settings of valves 13a, 13b, or 13c. Similarly, stored electrolyte may be caused to respectively exit the positive storage tanks 14a, 14b, or 14c toward the battery stack 10 through respective valves 15a, 15b, or 15c and along pipe line 16. Electrolyte from pipe line 16 may be pumped into the battery stack 10 by pump 17, for example, while the rate of flow of electrolyte into the battery stack 10 may be controlled by variable valve 18 and/or a controlled speed of pump 17. A same circulation of negative electrolyte takes place on the negative side (illustrated right side of FIG. 1) of battery stack 10.

In the example of FIG. 1, valve 15b may be in the open position allowing electrolyte stored in storage tank 14b to enter the output line 16 where pump 17 sends the electrolyte into the battery stack 10 for either charging or discharging of the electrolyte based on whether this flow battery string of FIG. 1 is in a corresponding charging or discharging mode. Pump 11 may then cause the positive electrolyte to return from the battery stack 10 and back to the same storage tank it came from, i.e., storage tanks 14b. As only an example, a single ‘pass’ of the electrolyte from storage tank 14b to the battery stack 10 and back to storage tank 14b may be considered the point when a complete initial volume of the electrolyte in the storage tank 14b passes through the battery stack 10. Thus, this electrolyte feeding and returning process between tank 14b and the battery stack 10 may continue for as many passes as necessary to charge the electrolyte to be 80% SOC when the flow battery is in the charging mode, and may continue for as many passes as necessary to discharge the electrolyte to be 20% SOC when the flow battery is in the discharging mode. Here, this example 80% charged level and the example 20% discharged level may herein be referred to as an 80/20 SOC limit, though embodiments herein are not limited to such a 80% charged limit and/or such a 20% discharged limit. For example, herein the example SOC limits may be limits based on the existing SOC of the underlying electrolyte about to be charged or discharged, or a desired partial charge or discharge of the underlying electrolyte. As another example, herein the example SOC limits may be about the example 80 and/or 20 SOC limits, with this meaning that the charging limit may be within a range around each of the SOC limits, such as within approximately ±20% SOC of the 80% SOC charged limit and within approximately ±20% SOC of the 20% SOC charged limit. Regardless, once a desired SOC percentage is reached the output valve 15b and input valve 13b are closed and the plumbing of the flow battery is controlled to open the relevant input/output valves of the next available storage tank in this string of storage tanks in a corresponding tank farm, such as input valve 15c and output valve 13c. Here, the storage tanks illustrated in FIG. 1 may be all of a particular string of storage tanks, or the negative storage tanks may be of a particular string of storage tanks and the negative storage tanks may be of a different particular string of storage tanks. Regardless, the combined string of storage tanks illustrated in FIG. 1 in association with the particular battery stack 10 (or associated bank of battery stack) may be referred to as single flow battery string, which may also be referred to as a first string of the flow battery.

Using the above cycling of electrolyte between the storage tank 14b and the battery stack 10, electrolytes of a current SOC percentage in the storage tank 14b, e.g., in a lower portion of the storage tank 14b, will be mixed with the electrolyte of a different SOC percentage having been returned from the battery stack 10, e.g., in an upper portion of the storage tank 14b. This mixing and re-circulation of the electrolyte in the storage tank 14b will continue until the desired SOC percentage is reached, at which time the input valve 13b and output valve 15b will be closed, and the input valve 13c and output valve 15c associated with storage tank 14c will be opened. The charging or discharging process then continues using storage tank 14c. A corresponding process may simultaneously take place on the negative side (illustrated right side) of the flow battery, which may include similarly arranged storage tanks, e.g., an ‘a’ storage tank similar to storage tank 14a, a ‘b’ storage tank similar to storage tank 14b, and a ‘c’ storage tank similar to storage tank 14c. Thus, the corresponding storage tanks for both the positive side and negative side of the flow battery of FIG. 1, e.g., the corresponding a, b, or c positive and negative sets of storage tanks, are used in turn until all the electrolyte has been charged or discharged. For example electrolyte may be cycling through the storage tank 14b at the same time that electrolyte is cycling through the ‘b’ storage tank of the negative side of the flow battery, and when 14b finally reaches the desired SOC percentage the ‘b’ storage tank of the negative side will have similarly reached the desire SOC percentage, and the cycling will then continue with another storage tank on each of the positive and negative sides of the flow battery. This process may be extended to any number of pairs of electrolyte storage tanks in the illustrated flow battery string of FIG. 1.

As another example, the moment in time shown in FIG. 1 represents that the positive side storage tank 14a and negative side storage tank “a” have been completely discharged down to a 20% SOC, for example, and the input valve 13a and output valve 15a on the positive side and the illustrated similarly arranged input and output “a” valves of the negative side are now closed. Similarly, at this moment, the storage tank 14b on the positive side and a corresponding storage tank “b” on the negative side are midway through a second pass (of three passes) of the battery stack 10 and include 58% SOC electrolyte, input from the battery stack 10, and 71% SOC electrolyte, next available for provision to the battery stack 10. Here, the 71% SOC electrolyte would be electrolyte that was previously input into the storage tank 14b, for example, from battery stack 10 with the flow battery being in a discharge mode, i.e., the 71% SOC is the discharged electrolyte from the first pass of the battery stack 10 when the battery stack discharged the original 80% SOC electrolyte from storage tank 14b. At this moment, the input valve 13b and output valve 15b on the positive side and corresponding input and output “b” valves on the negative side are also shown in their current open positions. Since, the full-tank approach is being implemented in FIG. 1, there will be some mixing of the 58% SOC electrolyte with the 71% electrolyte at the height of the storage tank 14b where they touch, e.g., around the middle of the storage tank 14b. Also at this moment, the respective electrolytes in the storage tank 14c on the positive side and the corresponding storage tank “c” on the negative side have not yet been used, which is why the respective electrolytes are shown as being 80% SOC. Additionally, the input valves 13c and output valve 15c and the input and output “c” valves on the negative side are shown in their closed positions.

In order for a constant amount of electric power to be maintained during either charging or discharging of the flow battery, the pump speeds may be continuously changed, according to one or more embodiments. For example, in a modified round-robin process, while charging the electrolyte, if the electrolyte in a storage tank of FIG. 1 begins at 20% SOC the pump speed may be controlled to operate at 10 gallons per minute (gal/min). Then, using the full-tank approach, the pump speeds may be continuously increased, in linear fashion, until at 80% SOC when the pumps may be operating at 40 gal/min. When the electrolyte flow is then switched to the next storage tank containing uncharged electrolyte, e.g., at 20% SOC, the pumps flow rates may be abruptly returned to the slower 10 gal/min flow rate. The abrupt changing of pumping speeds may cause fluid pressure spikes which may likely cause pipes to burst or pipe fittings to failure. Therefore, in one or more embodiments, the multiple-tank system may also be equipped with fluid pulsation dampers 1, 2, and 3 (for positive and negative sides of the flow battery) at the ends of each of the long lines to relieve the plumbing system of fluid pressure spikes, for example. The fluid pulsation dampers may be “hydropneumatic accumulators” or “hydropneumatic pulsation filters,” as only examples. Fluid pulsation dampers 1 may also be, or alternatively, installed in the pipe lines immediately following each pump and elsewhere in the plumbing system where needed.

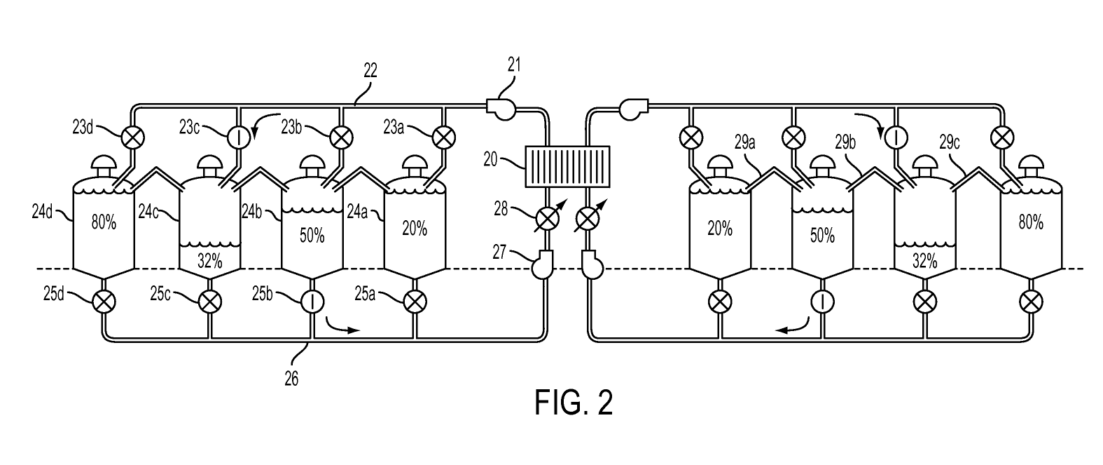

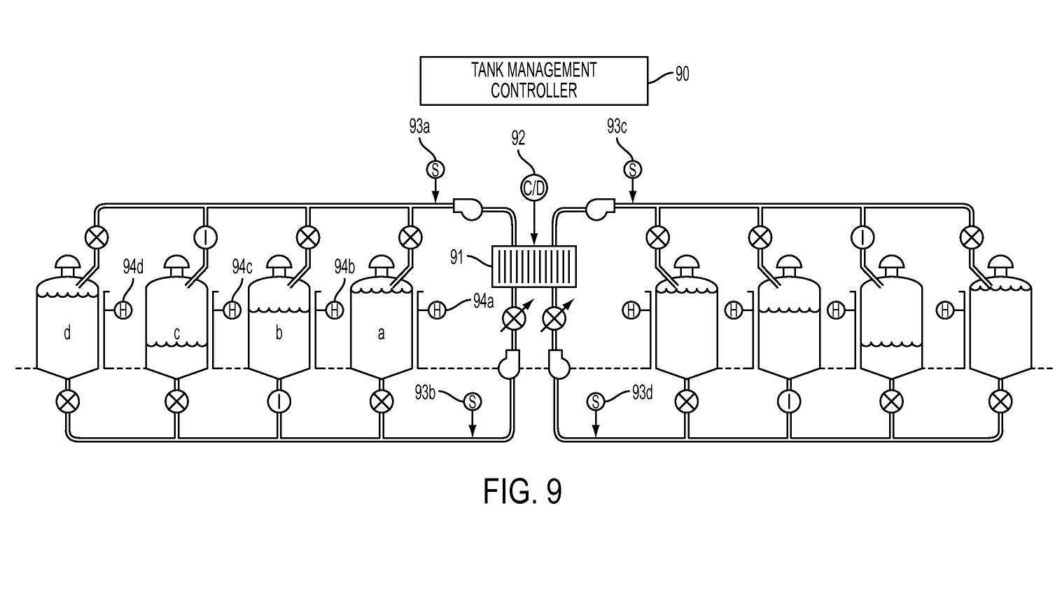

The fluid pulsation dampers have been omitted in FIGS. 2 and 9 merely to simplify the illustration. Thus, in one or more embodiments, fluid pulsation dampers may normally be installed at the ends, for example, of long fluid lines and following pumps in example embodiments described herein.

Snorkel mechanisms 4a, 4b, and 4c (for positive and negative sides of the flow battery) are generally installed on the tops of the electrolyte storage tanks. For example, the snorkel mechanisms may allow the electrolyte stored in each storage tank to remain at atmospheric pressure regardless of the height of fluid in the storage tank or the actions of the pumps. The snorkel mechanism may also help control the temperature of the electrolyte stored in the storage tank.

FIG. 2 illustrates an empty-tank multi-tank flow battery system and method, according to one or more embodiments.

In this example the flow battery may be equipped with four positive electrolyte storage tanks 24a, 24b, 24c, and 24d on the positive side (illustrated left side) of the flow battery, and four negative storage tanks on the negative side (illustrated right side) of the flow battery. Though there are four available storage tanks on the positive side of the flow battery, the positive side of the system may only contain sufficient positive electrolyte to fill three storage tanks, resulting in an equivalent of one storage tank volume remaining empty in the four storage tanks at any moment of time. This would be the same on the negative side of the flow battery. As shown in FIG. 2, storage tanks 24b and 24c are partially filled, so that together they contain only one storage tank volume of positive electrolyte. This is similarly reflected on the negative side of the flow battery.

In FIG. 2, electrolyte emerging from the top of the battery stack 20 on the positive side is fed through distribution line 22 by pump 21. Here, input valve 23c is open along line 22 so that the electrolyte is directed into storage tank 24c. Simultaneously, electrolyte is being caused to be withdrawn from storage tank 24b through the open valve 25b leading to pipe line 26 toward the battery stack 20. The withdrawn electrolyte through line 26 traverses through variable valve 28 and into an example bottom positive inlet port of the battery stack 20. Here, there is no limit on where the inlet and outlet ports, positive and negative, of the battery stack 20 are positioned. Such placements may be based on a particular configuration of the battery stack or bank of battery stacks and the designed application of the flow battery, or other reasons.

In the example shown in FIG. 2 the flow battery has been discharged with regard to storage tank 24a (20% SOC depletion) on the positive side and the corresponding storage tank on the negative side, while the flow battery has not yet been discharged with regard to storage tank 24d (80% SOC depletion) and the corresponding storage tank on the negative side. Further, FIG. 2 illustrates that one storage tank volume of electrolyte (during a second pass through the battery stack 20) being empty between storage tanks 24b and 24c. In this example second pass, the 50% SOC electrolyte will continue to be provided to the battery stack 20 and returned as 20% SOC to storage tank 24c until storage tank 24c is full of 20% electrolyte and storage tank 24b is empty. The transfer may take place as follows:

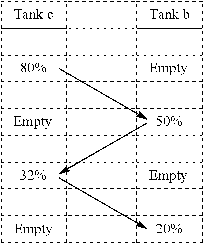

In this illustrated interval, the example process begins with Tank c being fully charged at 80% SOC and example Tank b having been emptied at the conclusion of the last interval of a discharging process. The contents of Tank c is caused to pass through the battery stack and emerges at 50% SOC and is directed into Tank b. After Tank c has been emptied in this first pass, the associated valves are switched and the content of Tank b is caused to be passed through the battery stack and emerges at 32% SOC and is directed into Tank c, during the second pass such as similarly illustrated in FIG. 2 with storage tanks 24b and 24c. Once Tank b has been emptied and Tank c is full of 32% SOC electrolyte, associated valves are again switched so as to allow the contents of Tank c to be sent through the battery stacks to finally emerge in Tank b at 20% SOC, until Tank b is full with 20% SOC electrolyte and Tank c is empty. Since it would typically be inefficient to attempt to extract more energy out of the 20% SOC electrolyte in Tank b, the valves may be reset so as to start discharging the 80% SOC electrolyte in an example Tank d using the then empty Tank c.

Note here that in an example embodiment the choice of using 3-pass electrolyte allows the empty storage tank to move up the chain in sequence in this empty-tank approach. If a 2 pass electrolyte, or any even numbered electrolyte, were used with a string of storage tanks in a discharging or charging mode then the empty storage tank in this sequencing may always be the initial empty storage tank, so that at the end of each interval of the electrolyte transfer process where electrolyte in a storage tank is charged or discharged, e.g., according to the 80/20 limits, the empty storage tank would not change at the end of the next interval of that charging or discharging process. Here, there may be no reason why the storage tanks need to be utilized in sequential order according to their physical arrangement, e.g., from storage tank 24b, to storage tank 24c, to storage tank 24d. The systematic use of the storage tanks in sequential order described herein is merely for organizational convenience for understanding the example charging or discharging processes.

In addition, the empty storage tank used in one or more of the empty-tank approaches described herein may physically be a separate storage tank that is not physically part of the string of equal volume storage tanks that store the electrolyte, and may even be a storage tank not part of the tank farm that includes the string of storage tanks. For example, a “facilitator tank” may be differently located closer to the battery stack(s), e.g., to minimize pumping requirements. The facilitator tank may be located above, below, or directly beside the battery stack and may have a different appearance than the other electrolyte storage tanks or be larger than the other storage tanks. In very large redox flow batteries where the electrolyte tank farm covers considerable real estate it may be expedient to have two facilitator tanks on either of the positive or negative sides, or both positive and negative sides, of the flow battery. In this configuration electrolyte can be pumped in from a distant location, passed once through the battery stack then transferred into a first facilitator tank. Thereafter the volume of electrolyte could be transferred back and forth between the two facilitator tanks and through the battery stack(s) until the desired SOC percentage is reached; after which the resulting electrolyte may be returned to the same remote storage tank that provided the electrolyte, and the next remote storage tank may then be used in a similar manor. Such facilitator tank(s) may be used for either of the empty-tank approach or the full-tank approach.

As only examples, in one or more embodiments, using the empty-tank approach and the storage tanks and battery stack of FIG. 2, storage tank 24a may initially be an empty tank and the modified round-robin sequencing may be designed so tank 24a is again empty after all of storage tanks 24b-24d have been fully discharged or fully charged in respective discharging or charging operations of the flow battery string of FIG. 2, storage tank 24a may be the facilitator tank and located closer to the battery stack 20 and/or separate from storage tanks 24b-24d. Similarly, in one or more embodiments, storage tanks 24a and 24b may be facilitator tanks and located closer to the battery stack 20 and separate from storage tanks 24c and 24d, and a modified round-robin sequencing may use these facilitator tanks (storage tanks 24a and 24b) to perform discharging or charging of electrolytes stored in storage tanks 24c and 24d, as only an example. Still further, there may be additional facilitator tanks. For example, storage tanks 24a through 24c (or through 24d) may all be facilitator tanks so that electrolytes from different storage tanks in a tank farm, e.g., including another storage tank and storage tank 24d, can be pumped into two of the facilitator tanks (storage tanks 24b-24c) and an empty-tank approach may be implemented using the three facilitator tanks (storage tanks 24a-24c). This way, while electrolytes pumped into one or more of the facilitator tanks (or directly into battery stack 20) are being discharged or charged by the battery stack 20 alternate electrolytes from storage tanks in the tank farm may be swapped, pumped into, or pumped out of facilitator tanks that are not currently being used in the discharging or charging operation. Here, in one or more embodiments, electrolytes from storage tanks of the tank farm may be directly provided to battery stack 20, initially by-passing the facilitator tank(s), and then discharged into the facilitator tank(s) after a first pass through the battery stack 20, or electrolytes having been fully discharged or charged using the facilitator tank(s) may be returned to the tank farm directly from the battery stack 20, without being first returned to the respective facilitator tank, as only examples.

Cross-over pipes 29a, 29b, and 29c of FIG. 2 are shown as connecting the storage tanks 24d-24a, for example, on the positive side of the flow battery. Likewise, the storage tanks on the negative side of the flow battery are shown as having similar cross-over pipes. The cross-over pipes may connect together the inert gas blankets that may exist at the tops of the storage tanks in order to equalize the pressure between the storage tanks. This may be necessary in order to maintain the same pressure above the electrolyte in all the storage tanks. Otherwise, changes in electrolyte levels caused by the transferring of electrolyte between storage tanks may cause changes in gas pressure above the respective electrolytes, which in turn may interfere with the pumping actions. Snorkel mechanisms are also illustrated in place at the tops of the storage tanks to maintain the gas pressures at near atmospheric pressure.

Other methods of distributing electrolyte between battery stacks and a multitude of storage tanks are possible. One approach would be to employ several individual and separate battery banks of respective battery stacks. One such arrangement would be to employ one battery bank for each pass required by the electrolyte. For example, if the electrolyte requires four passes through the battery stack to extract its energy from 80% SOC to 20% SOC, then the flow battery would be designed with four banks of battery stacks. But, as described herein, the electrolyte may desirably need to flow through the battery stacks at an ever faster flow rate as the electrolyte becomes depleted. This embodiment may also require that the banks of battery stacks each be a different size to accommodate the different flow rates. This example arrangement may also prove to be complex and inflexible to any change in the operating parameters.

In many applications it may be more desirable for a flow battery to provide a uniform power output throughout its discharge cycle at near its maximum rated power output. Normally, as the electrolytes become depleted the flow battery output power diminishes in linear proportion to the electrolyte's SOC percentage. For example, in this modified round-robin process, this diminishing of the flow battery output can in part be compensated for by increasing the flow rate of the electrolytes through a battery stack(s) by increasing the pump speeds. However, the output voltage may still continue to noticeably decrease as the electrolytes become depleted. When either the full-tank approach or the empty-tank approach is used to distribute electrolyte to the battery bank, the SOC percentage may go from 80% to 20%, e.g., if the 80/20 limits are used, each time one of the storage tanks is discharged through the battery stacks. This produces voltage output variations repeatedly as successive storage tanks are brought into use and depleted. In addition, it is found that if a round-robin sequencing is now applied to multiple strings of the flow battery, i.e., with a single string of the flow battery being shown in each of FIGS. 1, 2, and 9, then all strings of the flow battery may identically sequence at the same time. For example, when a storage tank of the string of storage tanks is newly providing electrolyte to the associated battery stack or bank of battery stacks the corresponding newly providing storage tank in each string of the flow battery may also simultaneously newly provide electrolyte to their associated battery stack or bank of battery stacks. As discussed below, such simultaneous sequencing may produce undesirable voltage output variations, as well as potentially unnecessarily tie up all strings of the flow battery to be in a charging mode or discharging mode, when potentially it could be desirable to have some flow battery strings operate in the charging mode while other flow battery strings operate in the discharging mode.

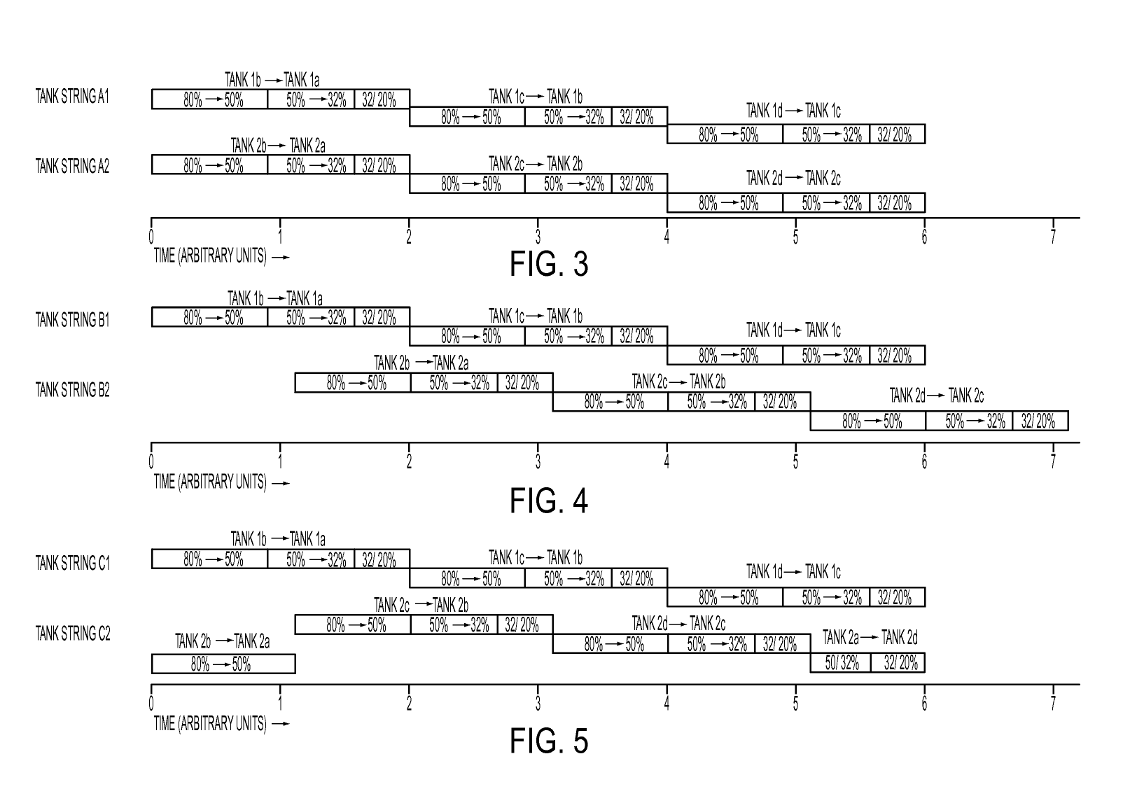

FIG. 3 is a Gantt chart of an empty-tank modified round-robin three-pass electrolyte distribution approach using two side-by-side tank farms respectively representing two different flow battery strings, according to one or more embodiments. FIG. 3 illustrates plots of the respective empty-tank three-pass electrolyte distribution of the two flow battery strings, e.g., each configured similarly to the flow battery string illustrated in FIG. 2. Storage tanks in flow battery string A1 will be collectively referred to as Tank String A1 and Storage tanks in flow battery string A2 will be collectively referred to as Tank String A2. If each of the flow battery strings include four positive and four negative electrolyte storage tanks, then because the empty-tank approach is being implemented, initially one of the positive and one of the negative electrolyte storage tanks in each flow battery string may be empty of a respective electrolyte, while three of the positive and three of the negative electrolyte storage tanks in each flow battery string may be full of the respective electrolyte. In total, these two flow battery strings have an example total of 16 electrolyte storage tanks, with the equivalent volume of four empty storage tanks at any given moment. Each flow battery string has its own bank of battery stacks. A time line is provided along the bottom of the Gantt chart. Flow battery discharge begins at time zero.

The Gantt chart of FIG. 3 shows an order and timing of the respective electrolyte transfers for an example modified round-robin empty-tank approach. The process in storage tank string A1 begins with empty storage tank 1a and full storage tank 1b, where storage tank 1b begins with 80% SOC. The transfer between storage tanks 1a and 1b may take place three times, i.e., in three passes in this example. In the first pass the electrolyte is depleted from 80% to 50% SOC, on the second pass the electrolyte is depleted from 50% to 32%, and on the third pass the electrolyte is depleted from 32% to 20%, as shown in the first three boxes of the upper Gantt chart time line for Tank String A1. At the completion of the third Gantt box, at the illustrated Time “2”, storage tanks 1a and 2a accordingly contain 20% SOC depleted electrolyte and storage tanks 1b and 2b are empty. Activity then switches to the next two storage tanks in each storage tank string, i.e., storage tanks 1b and 1c in Tank String A1 and storage tanks 2b and 2c in Storage Tank A2. The sequence of activities are then repeated for the next two sets of storage tank transfers for both Storage String A1 and Storage String A2, ending with all the storage tanks, except storage tanks 1d and 2d, containing depleted electrolyte at 20% SOC. At this point storage tanks 1d and 2d would be empty.

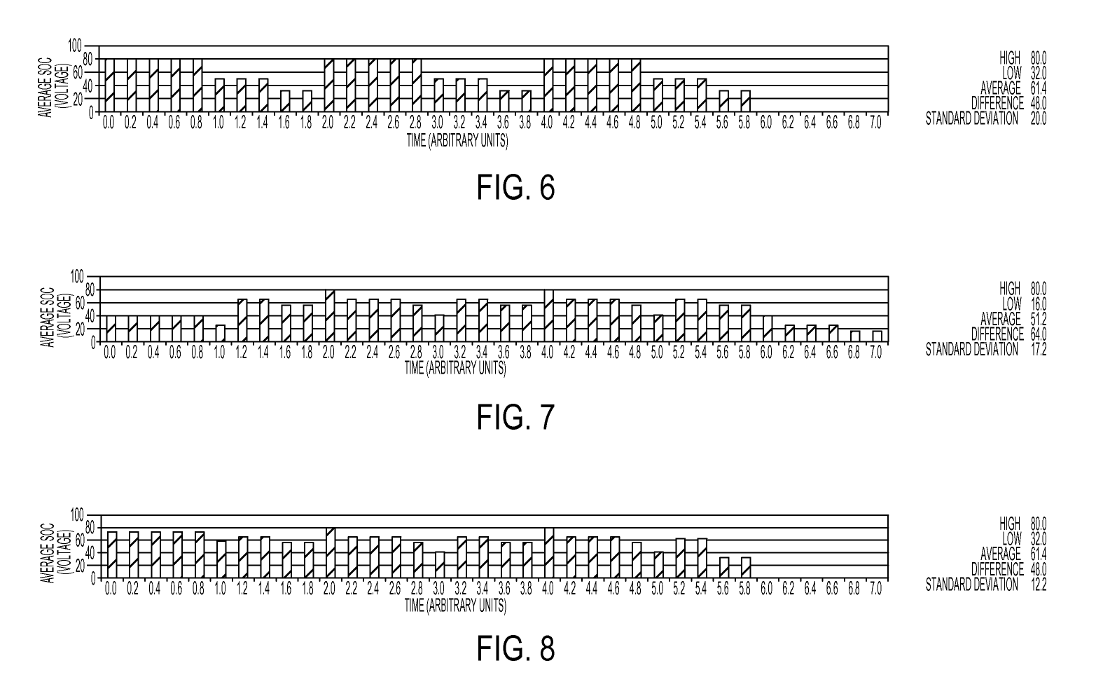

Note that in the Gantt chart of FIG. 3, the respective three transfers within each illustrated triple box set are not of equal length along the time axis. In FIG. 3, in the corresponding first pass, the electrolyte in storage tank 1b is transferred to storage tank 1a in 1.000 unit of time, resulting in storage tank 1a being full of 50% SOC electrolyte. The contents of storage tank 1a is then transferred back to storage tank 1b in 0.625 units of time, resulting in storage tank 1b being full of 32% SOC electrolyte. Finely, the contents of storage tank 1b is transferred back to storage tank 1a in 0.400 units of time, resulting in storage tank 1a being full of 20% SOC electrolyte. The same unequal time duration may be repeated for each transfer set of three transfers/passes. These different durations represent different pump speeds for the electrolyte being provided to the respective battery stacks, so that each time a lower SOC percentage electrolyte is provided to the battery stack the pump speed is increased to compensate and allow approximately the same amount of power to be withdrawn from the electrolyte at each moment in time. Here, the flow battery still suffers a slight voltage loss as the SOC percentage decreases, as will be discussed with regard to FIG. 6. Briefly, the illustrated Gantt box lengths in FIGS. 3-5 have been arranged along the time axis for clarity of understanding in these charts. This unequal length for different stages of electrolyte transfer becomes significant in the more complex transfer approaches discussed below. In addition, the example shown in FIG. 3 employs two identical storage tank strings, instead of one string, in order to be more easily comparable to the examples of FIGS. 4 and 5.

FIG. 4 is a Gantt chart of an empty-tank modified round-robin three-pass electrolyte distribution approach using two side-by-side tank farms having staggered timing between the two tank farms, according to one or more embodiments. This example in FIG. 4 shows a Gantt chart of two storage tank strings Tank String B1 and Tank String B2, with the transfer operations of Tank String B2 being delayed by 1.2 units of time. When the outputs of the two strings are averaged together this time off-set provides a more uniform power distribution over time. The 1.2 units of time off-set was selected as an example so that none of the change-overs between one set of storage tanks and another set of storage tanks, both in Tank String B1, occur at the same moment in time as any change-overs in Tank String B2. This is different from the example empty-tank modified round-robin approach of FIG. 3, where all change-over's occur in both Tank Strings A1 and Tank String A2 at the same time which, in the physical implementation, would likely cause momentary disruptions in the combined output power of the flow battery. Rather, the example empty-tank modified round-robin approach of FIG. 4 may help achieve a more uniform power distribution than that of FIG. 3. A disadvantage of this method of combining the power output from two strings of electrolyte storage tanks is that for the first 1.2 time units and the last 1.2 time units only one string of storage tanks is providing output power for the flow battery. With only these two tank strings in the flow battery, for example, this would reduce the average power output of the flow battery system and prolong its charge or discharge period.

FIG. 5 is a Gantt chart of an empty-tank modified round-robin three-pass electrolyte distribution approach using two side-by-side tank farms having staggered timing between the two tank farms with start-up adjustments, according to one or more embodiments. This staggered timing with start-up adjustments storage tank scheduling approach shown in FIG. 5, solves the potential problems of the approach of FIG. 4 by implementing a slightly different sequencing of the different transferring operation that results in tank 2a being the empty tank at the end of the entire transferring operation, rather than tank 2d as implemented in the approaches of FIGS. 3 and 4 for the same three-pass electrolyte. Using the illustrated different sequencing reduces the time of performance while maintaining the advantages of a staggered scheduling. However, in order to accomplish this the first Gantt box of Tank Sting C2 is expanded to 1.2 time units. This means that the pump speed is reduced slightly causing 20% reduction in power output from that first transfer for a period of 1.2 time units. Then, rather than completing the discharging of the electrolyte transferred from tank 2b to tank 2a, the discharging of the electrolyte in tank 2a is suspended and the transfer process between tanks 2c and 2b are begun well before the similar transfer process between tanks 1c and 1 b for Tank String C1. Accordingly, when the last transfer process between tanks 1d and 1c for Tank String C1 is being completed, the previously suspended discharging of tank 2a is completed for Tank String C2. Because the first transfer between tanks 2a and 2b was extended by 20% or 0.2 time units, this last transfer between tanks 2a and 2d for Tank String C2 has been compressed to 0.366 and 0.234 time units respectively. Here, these different time lengths for the last two transfers/passes for tanks 2a and 2d are not shown to scale in the illustrated Gantt chart of FIG. 5. In this example approach of FIG. 5, the higher pump speeds needed to accomplish these transfers for shorter periods of time, e.g., shorter than the 1.0 time unit, may have to be built into the design of the flow battery system.

FIG. 6 is a chart of a voltage output proportional to the SOC percentage of an empty-tank modified round-robin three-pass electrolyte distribution approach using two side-by-side tank farms, according to one or more embodiments, FIG. 7 is a chart of a voltage output proportional to SOC percentage of an empty-tank modified round-robin three-pass electrolyte distribution approach using two side-by-side tank farms having staggered timing between the two tank farms, according to one or more embodiments. FIG. 8 is a chart of a voltage output proportional to SOC percentage of an empty-tank modified round-robin three-pass electrolyte distribution approach using two side-by-side tank farms having staggered timing between the two tank farms with start-up adjustments, according to one or more embodiments. Here, the charts of FIGS. 6-8 respectively show example results of using the three different storage tank transfer scheduling approaches, respectively shown in FIGS. 3-5, for an over-all flow battery performance. Each plot of FIGS. 6-8 make use of a realization that the output voltage of a battery cell of a battery stack is proportional to the SOC percentage of the electrolytes entering the battery cell and used to produce the electrical output during a discharging mode of the flow battery. These plots of FIGS. 6-8 therefore provide a rough measure of a performance of the battery cell by simply using a recorded SOC percentage of the electrolyte entering the battery cell. The performance of interest here is not the absolute power output in time, but the relative fluctuations in power over a complete discharge cycle of the entire flow battery. Using this measure it becomes visually apparent that FIG. 6 has some rather severe jumps in output voltage that occur as transfer is made between successive storage tanks in the modified round-robin chain of FIG. 3, for example. The changes in voltage output become less dramatic in FIG. 7, and even smoother in FIG. 8.

Thus, as noted, FIGS. 6-8 demonstrate performance parameters for the three electrolyte transfer approaches respectively demonstrated in FIGS. 3-5. All three approaches have an example same high output readings of 80. The approaches of FIGS. 3 and 5 demonstrate in FIGS. 6 and 8 low readings of 32, while the staggered timing approach of FIG. 4 demonstrates in FIG. 7 a very low output readings of 16 in the last portion of its cycle. The approach of FIG. 4 therefore has the greatest difference between high and low performances. The average power output of the approaches of FIGS. 3 and 5 are demonstrated in FIGS. 6 and 8 as being the same at 61.4, while the average reading for the approach of FIG. 4 is demonstrated in FIG. 7 as dropping to 51.2 as the flow battery output is spread out over a longer time period.

A performance index of potentially greatest interest is the standard deviation, which indicates the amount of variation in flow battery output. For example, it may be desirable to have the smallest possible amount of variation in flow battery output over time. In this measure the differences between the approaches of FIGS. 3-5 is most apparent. The approach of FIG. 3 without staggered timing is demonstrated in FIG. 6 as having a standard deviation of 20.0. The approach of FIG. 4 with staggered timing is demonstrated in FIG. 7 as having the standard deviation drop to 17.2. The approach of FIG. 5 with staggered timing and adjustments is demonstrated in FIG. 8 as having a standard deviation drop even further to 12.2.

When implementing the approach of FIG. 3, for either the full-tank approach or the empty-tank approach, a saw-tooth voltage output is shown in FIG. 6 as having a high standard deviation. But the standard deviation variations in output voltage of a multiple electrolyte storage tank system can be greatly reduced using the staggered timing with adjustments approach of FIG. 5 for either the full-tank or the empty-tank approaches of distributing electrolyte in a flow battery. Such example embodiments of the present disclosure represent a major improvement in large flow batteries with multiple storage tanks that may deliver many hours of reliable electric power with minimum fluctuations in output voltage.

Here, though particular transfer schedules are demonstrated in FIGS. 3-5, embodiments are not limited thereto, as alternative schedules may be used based on the disclosure herein. In addition, though the sequencing between tanks may be particularly defined so that a particular tank is first selected for transfer, and a second particular tank is selected for the next transfer, etc., one or more embodiments operate equally well when such selections are randomized, or implemented in differing orders for different circumstances. For example, as flow battery operations proceed over time and events occur, such as storage tank repairs, multiple switching between charge and discharge, changes in requirements, and etc., it is quite likely that the original physical sequence of storage tank organization may need to be changed.

FIG. 9 illustrates a flow battery system including a storage tank management controller system, according to one or more embodiments. In addition to previous discussed components, FIG. 9 also illustrates example components of a storage tank management controller (STMC) 90 configured to control the transfer of electrolyte between multiple storage tanks and the battery stack 91 or battery bank of multiple battery stacks, according to one or more embodiments. At a minimum the controller may contain information on the current amount of electrolyte in each storage tank, the current SOC percentage of the electrolyte in each storage tank, the status of each pump and valve, the current electrolyte flow rates, and knowledge of the flow battery's current charge/discharge state, for example. Using such information in an internal algorithm the STMC then issues electrical commands and provides electric power to the various system valves and pumps to carry out the desired schedule of electrolyte transfers between storage tanks and their associated battery stack or battery bank. The STMC may be in communication with various sensors and components of the flow battery, such as wires connecting the various sensors to the STMC, wires connecting the STMC to pumps, valves, and other components, or through other methods, such as wireless methods.

In FIG. 9, a vertical line is illustrated alongside each of the storage tanks and includes a circle containing the letter “H” that symbolize sensors that measure the height of electrolyte contained in their respective storage tanks, as only an example. On the positive side of the flow battery of FIG. 9 such electrolyte height sensors are labeled 94a, 94b, 94c, and 94d. The height sensors can be float type level indicators, ultrasonic level sensors, pressure-sensing liquid fluid level indicators, or any other commercially available type of sensor that can be used to indicate the height of electrolyte in the storage tanks.

FIG. 9 further illustrates several small circles each containing the letter “s” and having an arrow pointing to a pipe line, for example, labeled 93a, 93b, 93c, and 93d, which are SOC sensors pointing to positions where the SOC percentage may be measured and the information sent to the STMC, noting that alternative measurement placements or methods of providing such SOC percentage information are equally available. As only an example, SOC sensors are being developed for all-vanadium flow batteries that analyze the spectral color of the electrolyte to determine the SOC percentage. Other SOC sensors may include very small battery cells designed to produce a voltage proportional to the electrolyte SOC percentage. These SOC sensors, or other type SOC sensors that may be developed in the future, may be used to supply such SOC information to the STMC.

FIG. 9 further illustrates element 92 that includes a circle encompassing the letter combination “C/D”, which represents a sensor that may represent the current mode, e.g., between a charge mode, discharge mode, or idle mode, for a particular flow battery string, e.g., a collective of a particular string of positive and negative storage tanks and associated battery stack(s). As only an example, the C/D sensor may be a stand-alone sensor attached to particular string of the flow battery to inform the controller of the respective status of the particular string, or it may be combined with other electronic components, such as the inverter included in the flow battery, or SOC sensors, so as to be indistinguishable as a stand-alone device, if desired. In addition, the charge/discharge sensor may be a virtual sensor existing within the STMC, or within the flow battery system controller, that by way of the STMC's current operation, or by use of an algorithm, determines the charge/discharge state of each particular flow battery string. The C/D reading may assist the STMC in determining the past, current, and/or scheduled future point along example predefined (or predetermined) transfer sequences, such as along the time lines of the three Gantt charts of FIGS. 3-5.

The STMC may also determine and/or control whether each of the storage tank input and output vales valves, or other valves, such as the valve controlling the inlet of electrolyte to the battery stack, is currently in the open or closed position. This process may occur in varying ways depending on the type of the valve mechanism being implemented. As only an example, the STMC may send a single electrical pulse to open a particular valve and to simultaneously record the valve as being open in computer memory. Alternately, a sensor may be installed in the valve to inform the STMC if the valve is open or closed when queried by the STMC.

Additionally, the STMC may determine the current flow rates of electrolyte into and out of each storage tank or into and out of each battery stack(s) at any given moment, for example. To accomplish this, the STMC may receive electrical signals from each of the system pumps that directly or indirectly provide current flow rates throughout the system. A direct method could be to include flow rate sensors as a part of each pump, whereby these sensors periodically send their flow rate measurements back to the STMC, for example. In one or more embodiments, since the pumps may generally be variable speed pumps controlled by the STMC, for example, the electrical signal/power being sent to the pumps by the STMC may be used to determine, e.g., through an algorithm, an estimate of the flow rate of the pump based on the controlled speed. As another example, another method of directly determining the electrolyte flow rate is to measure the rate at which the height of the electrolyte changes in the storage tanks, e.g., as determined by height sensors 94a, 94b, 94c, and 94d on the positive side of FIG. 9.

In one or more embodiments, the STMC algorithm may implement one of the transfer schedules provided in FIGS. 3-5, or some variation of these schedules based on the description herein, by sending control signals and electric power to the various valves and pumps of the system. For example, a Gantt chart schedule similar to the Gantt charts in any of FIGS. 3-5 may be determinative of the expected SOC percentage in each storage tank at any given moment and the desired flow rates controlled by the STMC to meet the schedule requirements.

However, it should be noted that osmotic water transfer between electrolytes, variations in expected pump speeds, temperature related performance variations, and other influences on system variation will generally act to disrupt scheduled performance. The STMC algorithm may then adjust the pump speeds based on such influences to meet the scheduled storage tank transfers, for example. Failure to do so may lead to gaps and pile-ups in delivery of electrolyte to the different strings of the flow battery and potential eventual chaotic system performance.

The above discussion used the example of a charged flow battery undergoing discharge. Rather, when charging, the direction of flow between storage tanks may be reversed while the direction of flow through the different strings of the flow battery may remain the same. Furthermore, in one or more embodiments, it would not be uncommon for a flow battery to reverse its operation from discharge to charge, or vice-versa, mid-way through the respective operations of the strings of the flow battery. This would be particularly true if the flow battery were connected to a wind farm or large solar array, where the input power would be intermittent and the line load varies with usage. For example, using the configuration of FIG. 2, where the flow battery is in discharge mode, if there is a determined need to suddenly control the flow battery to change to a charging mode, valves 23c and 25b could immediately be closed and valves 23b and 25c could immediately and simultaneously be opened. The negative side of the flow battery may operate similarly. As only an example, if all four pumps were operating at pump speeds of 1.60 units/time of flow they may be controlled to change to operate at pump speeds of 1.56±Δ units/time. Thus, instead of having the contents of storage tank 24b (at 50% SOC) being discharged into storage tank 24c (at 32% SOC), the transfers between the two storage tanks would be reversed so that the electrolyte in storage tank 24c (at 32% SOC) would be charged and sent into storage tank 24b (at 50% SOC). The negative side of the flow battery may operate similarly. In the next pass the electrolyte in storage tank 24b (at 50% SOC) would be charged and sent into storage tank 24c (at 80% SOC) leaving storage tank 24b empty. The electrolyte stored in storage tank 24a may then be charged in three passes and end up in storage tank 24b, leaving storage tank 24a empty.

Note in the above example, where the pump speed for charging the flow battery was given as 1.56±Δ units/time to charge the flow battery from 32% SOC to 50% SOC as compared to running the pumps at 1.60 units/time to discharge the flow battery from 50% SOC to 32% SOC. These numbers assume that a maximum allowed pump speed is 2.50 units/time that may cause a scaling down of the charging pump times. In addition to pump speed considerations, the time required to charge the flow battery is generally longer than the time required to discharge the flow battery. This difference in charge/discharge times is taken up by the ±Δ factor. This difference in charge/discharge times may requires that the Gantt charts of FIGS. 3-5 be altered to have different time scales for charging and discharging. This would generally be handled easily by the aforementioned STMC since the flow battery is either in the charge mode or the discharge mode, not both. This similarly should be easily handled by the STMC even if one flow battery string is in a charge mode while a second flow battery string is in discharge mode, because in this case the outputs of the two strings may not be added together.

Still further, depending on embodiment, there are many possible variations of the Gantt chart schedules/algorithms discussed with regard to FIGS. 3-5 that may be used by the STMC to schedule operations of the flow battery. For example, in one or more embodiments, the particular flow battery system may use 1, 2, 3, 4, 5, or more passes through the battery stacks to reach its charged or discharged condition. In addition, the above example 80/20 charged/discharged limit condition may be different than the 80/20 limit or may merely vary from the 80/20 SOC percentages, e.g., depending on chemistry, temperature, and many other parameters. For example, if a particular flow battery uses four passes to charge or discharge the electrolyte, the described example limits could be changed to be 83/19. Each storage tank string may have two or more storage tanks and each string of battery stacks may include two or more battery stacks. There may be two or more storage tank strings and there may be two or more flow battery strings, i.e., two or more respective collections of a string of storage tanks and an associated storage stack(s). It is anticipated that some storage tank farms may be quite large as larger storage requirements are needed. A number of storage tanks may be combined into one very large storage tank with multiple chambers, for example. In some applications the storage tanks may be of unequal size. One or more embodiments may implement the above described charging/discharging approaches may be expanded to include any of such variations, and other expansions of these concepts as they may arise.

Still further, as only an example, in one or more embodiments, the flow battery may be an all-vanadium redox flow battery (VRFB). In such a VRFB, the positive electrolyte contains VO2+ ions, which undergo a reduction reaction to VO2+ plus electricity during its discharge cycle. The opposite oxidation reaction takes place during the charging of the VRFB, where VO2+ ion plus electricity are transformed back to VO2+ ions. In the negative electrolyte V2+ ions undergo an oxidation reaction to yield V3+ ions plus electricity during its discharge cycle. During the charging cycle V3+ ions plus electricity in the negative electrolyte is reduced back to V2+ ions. Herein, these four vanadium valence states can be be written as V(5), V(4), V(3), and V(2). The charge/discharge states in the positive electrolyte may be represented as V(5)/V(4) and the charge/discharge states in the negative electrolyte may be be represented as V(2)/V(3).

Still further, in one or more embodiments, the example concepts of the flow battery systems described herein include all types of flow batteries such as iron/tin, iron/titanium, iron/chrome, sodium/bromine, zinc/bromine, and other possible reactant couples. One or more embodiments include an all vanadium flow battery (where the positive reactant couple is VO₂⁺/VO²⁺ and the negative couple is V³⁺/V²⁺), and the all chrome redox flow battery (where the positive couple is Cr⁵⁺/Cr⁴⁺ and the negative couple is Cr³⁺/Cr²⁺), and other single element redox flow batteries.

One or more embodiments should not be considered limited to the specific examples described herein, but rather should be understood to cover many aspects of the invention. Various modifications, equivalent processes, as well as numerous structures and device substitutions may be applicable readily available.

The electrolyte storage tanks may be made of high density polyethylene, lined metal, flexible rubber-coated fabric, or other acid resistant materials that can withstand the pressure and containment requirements. For example, the storage tanks may be acid resistant high density polyethylene (HDPE) storage tanks. In addition, it is not intended that the electrolyte storage tanks described in this disclosure be limited to the singular description provided in the drawings. Accordingly, the storage tanks need not be cylindrical; they may be spherical, rectangular, or have any other symmetrical or non-symmetrical shape. They may be positioned horizontally or vertically. They need not be resting on the ground; they may instead be positioned above or below ground level within the limits set by their function. The storage tanks may have any volume, e.g., commensurate with their function, and may be sized in accordance with the over-all size of the flow battery system and the designed flow rates in the flow battery. The electrolyte storage tanks may be housed indoors, or outdoors, or that may be housed under shelters that partially shield the storage tanks from the most extreme weather variations.

The storage tanks may be self-supporting, or be mounted within a supporting structure. The storage tanks would generally be mounted on, or be surrounded by, a containment tray, or catch basin, or other mechanisms to prevent electrolyte leaks or spills from entering the environment. The bottoms of the storage tanks may funnel the fluids to the output plumbing, or be flat, or have any other shape determined by function or design. The storage tanks may include heating elements or cooling mechanisms as required and may be housed outdoors or indoors. The storage tanks may have multiple input and output mechanisms, access ports, viewing ports, sensor attachment mechanisms, and other accessories. Several electrolyte storage tanks may be designed as a single multi-chambered structure to save space, or clustered together with other storage tanks or components.

The pumps providing the electrolyte to the battery stack are generally variable-speed, electrically-powered, and constructed of materials and that can resist the corrosive effects of the electrolyte acids. The pumps could generally include built-in backflow prevention valves and may be centrifugal type pumps, lobe pumps, peristaltic pumps, or other suitable type pump, for example. In addition, the flow of electrolyte into and out of the storage tanks may also be regulated by the any of the valves disclosed in FIGS. 1-2 and 9 being actuator controlled valves. Signals from a system controller, or dedicated controller, to the valve actuators may control the opening and closing of these valves. Electrolyte may be pushed into the appropriate inlet of the battery stacks by a combination of a variable speed pump, a back-flow prevention valve, an actuator controlled variable valve, and possibly pressure and/or flow sensors to signal the controller the amount of electrolyte entering the battery. As only an example, the variable valve may be replaced by a pressure balancing valve also referred to as a constant pressure valve.

Any or all functions of a flow battery according to one or more embodiments may generally be controlled by a system “controller”. For example, the controller may be a computer mechanism whose operation may be governed by software algorithms. Electronic signals from a variety of sensors from throughout the system, such as temperatures, fluid pressures, SOC percentage, etc. are sent to the controller, where they are used by the controller's algorithm to determine the current operational state. Based on such current information the system controller may send out electrical signals to control various system components, such as the pumps, heaters or coolers, charge or discharge rates, etc. The distribution of electrolyte, at various SOC percentages and various pumping speeds; during the charge, discharge, and idle operation of the flow battery; may also, or alternatively, be controlled by a dedicated “storage tank management controller” (STMC), which may be a stand-alone controller, or may reside as a function within the over-all system controller. For example, the STMC of FIG. 9 may illustrate a system controller for a majority or all operations of the flow battery, or merely such a stand-alone controller for potentially limited purposes.

Here, the Storage Tank Management Controller (STMC) may be any digital or analog mechanism configured to control operations of the flow battery so embodiments described herein are implemented. The STMC may be housed in a stand-alone structure, or it may be contained within or integrated with the main system controller, such as the above described controller, or it may be distributed throughout the flow battery system, or it may reside at a remote location and be connected by the Internet to the flow battery system. The STMC may generally be guided by an algorithm, which generally takes the form of a computer code. The STMC and its coded algorithm may be made amenable to changes in operating parameters by hardware or software implementing mechanisms. Generally the STMC may be assumed to be a computer mechanism, though embodiments described herein also include manual operation, remote operation, mechanical activation, or any other mechanism controlling the pumps, valves, and other actions that may be performed to for implementations of such embodiments.

One or more embodiments further include a “power inverter” to electrically connect the flow battery to sources and consumers of electric power. This complex device may generally convert the battery DC electric power to AC power required by the grid and most other types of electric load. The power inverter may also include rectifiers to convert incoming AC power to the DC power required by the flow battery. The power inverter may also switch the battery between the charging and discharging modes, ensure that the outgoing AC power is in-phase with the grid power, and/or serve to step-up or step-down the voltage as required. The power inverter may be included in the controller of the flow battery.

Still further, arrangements of components shown in the drawings and expressed in the descriptions herein generally shows symmetry between the positive and negative sides of the flow battery. However, the different reactant chemistry on each side of the flow battery may make it advantageous to employ different methods of distributing the electrolyte on the two sides of the flow battery. In addition, the quantity of positive electrolyte may differ from the negative necessitating a difference in scale between the two sides of the flow battery. For these and other possible reasons, in one or more embodiments the design of the flow battery may be asymmetric. Regardless of symmetry, above described aspects of the present invention may be applied to any symmetric or asymmetric flow battery arrangement, of any workable size, scale, or configuration as appropriate.

Though the illustrated plumbing connecting the electrolyte storage tanks to the battery stack(s) is a more simple form in the drawings, this is done merely to enhance clarity of understanding of the electrolyte flow paths. Further, though a limited number of pumps are illustrated, this is again done merely to enhance clarity of the description of embodiments, for example there may be additional pumps, additional safety and control valves, one-way valves, heat exchangers, sensor and sample access mechanisms, viewing ports, redundant and alternative flow paths, clean-out ports, disconnect unions, filtering mechanisms, venting mechanisms, and other components. The three-port valves, such as valves 18 in FIG. 1 or any of the illustrated valves, described herein may be hydraulic, pneumatic, manual, solenoid, or motor controlled, or of whatever other type serves the function of this invention. The pipes and other plumbing components may be made of plastic, glass, metal, or other suitable acid-resistant materials, as only examples.

Still further, in one or more embodiments, a large flow battery may contain hundreds of battery stacks, which may or may not be divided into strings of battery stacks, generally mounted on metal racks, in which each rack may contain several shelves at different heights. The racks may be fabricated out of steel, but could be made of wood, plastic, or other suitable materials. The mounting racks would generally include mechanisms to bolt the racks to the floor, mounting mechanisms for the tubes, pipes, wires, and the like, and mounting mechanisms for sensors, controllers, valves, switches, and the like. Individual racks may be attached together to form a three dimensional matrix of shelving for the support of many battery stacks. The storage racks may be mounted in a catch basin or tray to contain electrolyte spills.

While aspects of the present invention has been shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A flow battery system comprising:
a first battery stack including a first half-cell configured to charge and/or discharge a positive or negative liquid electrolyte;
a first feed system to provide electrolyte to the first battery stack, including at least a first storage tank initially storing a first electrolyte having a first state of charge (SOC) and a second storage tank initially storing a second electrolyte having a second SOC;
a first return system to return one of the positive electrolyte or negative liquid electrolyte from the first half-cell of the first battery stack to one of the first storage tank and the second storage tank with a higher SOC during a charging of the first or second electrolytes and with a lower SOC during a discharging of the first or second electrolytes; and
a controller to control a defined sequence for a selected mode of one of charging or discharging of the first and second electrolytes, so as to accordingly charge or discharge the first electrolyte before charging or discharging the second electrolyte based on the selected mode.

2. The flow battery system of claim 1, wherein the first feed system includes a third storage tank that does not store electrolyte at least once during the charging or discharging of the flow battery system.

3. The flow battery system of claim 1, wherein the controller controls the sequence so as to control the first electrolyte from the first storage tank to be charged or discharged, according to the selected mode, after being returned from the first battery stack to the first storage tank, so as to mix charged first electrolytes existing in the first storage tank with differently charged first electrolytes returned to the first storage tank from the first battery stack.

4. The flow battery system of claim 3, wherein the controller controls the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

5. The flow battery system of claim 4, wherein the determined high SOC level is about 80% SOC and the determined low SOC level is about 20% SOC.

6. The flow battery system of claim 4, wherein the determined high SOC level and/or the determined low SOC level are respectively controlled to change based on a determined number of passes of a full volume of the first or second storage tanks required to transit through the first battery stack to increase the respective first SOC or second SOC to the determined high SOC level or to decrease the respective first SOC or second SOC to the determined low SOC level.

7. The flow battery system of claim 4, wherein the determined high SOC level and/or the determined low SOC level are respectively controlled to change based on a determined amount of osmotic water transfer between the first half-cell and another half-cell and/or determined temperature of the first electrolyte and/or the second electrolyte.

8. The flow battery system of claim 4, wherein the controller controls a first point in time to implement the sequence for controlling the first electrolyte from the first storage tank to be charged or discharged, according to the selected mode, to be different from a second point in time when an other sequence is implemented controlling a first other electrolyte from a first other storage tank in a second flow battery string, different from a first flow battery string that includes at least the first battery stack and the first feed system and the first return system, to be charged or discharged according to the selected mode, so that full charging or full discharging of respective electrolytes from differing storage tanks in the first flow battery string occur at different times than full charging or full discharging of respective electrolytes from differing storage tanks in the second flow battery string.

9. The flow battery system of claim 8, wherein the controller controls the differing flow rates for the first flow battery string to be selectively different from differing flow rates for the second flow battery string implementing the other sequence.

10. The flow battery system of claim 9, wherein the controller controls the differing flow rates for the first flow battery string to be selectively different from the differing flow rates for the second flow battery string so that each full charging or full discharging of respective electrolytes stored in all storage tanks in the first flow battery string occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

11. The flow battery system of claim 1, wherein the controller controls the sequence for a charging or discharging, according to the selected mode, of the first electrolyte between the first storage tank and an empty tank to occur before a charging or discharging, according to the selected mode, of the second electrolyte between the second storage tank and the first storage tank, so that the first electrolyte from the first storage tank having been charged or discharged, according to the selected mode, by the first battery stack is returned to the empty tank and the second electrolyte from the second storage tank having been charged or discharged, according to the selected mode, by the first battery stack is returned to the first storage tank.

12. The flow battery system of claim 11, wherein the controller controls the sequence so that when the charging or the discharging of the first electrolyte is complete the empty tank becomes full with the first electrolyte after having been fully charged or discharged by the first battery stack and then the second electrolyte stored in the second storage tank is charged or discharged by providing the second electrolyte from the second storage tank to the first battery stack and returned to the first storage tank after having been fully charged or discharged by the first battery stack until the second storage tank is empty and the first storage tank is full of the fully charged or discharged second electrolyte.

13. The flow battery system of claim 11, wherein the controller controls the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

14. The flow battery system of claim 13, wherein the determined high SOC level is about 80% SOC and the determined low SOC level is about 20% SOC.

15. The flow battery system of claim 13, wherein the determined high SOC level and/or the determined low SOC level are respectively controlled to change based on a determined number of passes of a full volume of the first or second storage tanks required to transit through the first battery stack to increase the respective first SOC or second SOC to the determined high SOC level or to decrease the respective first SOC or second SOC to the determined low SOC level.

16. The flow battery system of claim 13, wherein the determined high SOC level and/or the determined low SOC level are respectively controlled to change based on a determined amount of osmotic water transfer between the first half-cell and another half-cell and/or determined temperature of the first electrolyte and/or the second electrolyte.

17. The flow battery system of claim 13, wherein the controller controls a first point in time to implement the sequence for controlling the first electrolyte from the first storage tank to be charged or discharged, according to the selected mode, to be different from a second point in time when an other sequence is implemented controlling a first other electrolyte from a first other storage tank in a second flow battery string, different from a first flow battery string that includes at least the first battery stack and the first feed system and the first return system, to be charged or discharged according to the selected mode, so that full charging or full discharging respective electrolytes from differing storage tanks in the first flow battery string occur at different times than full charging or full discharging of respective electrolyte from differing storage tanks in the second flow battery string.

18. The flow battery system of claim 17, wherein the controller controls the differing flow rates for the first flow battery string to be selectively different from differing flow rates for the second flow battery string implementing the other sequence.

19. The flow battery system of claim 18, wherein the controller controls the differing flow rates for the first flow battery string to be selectively different from the differing flow rates for the second flow battery string so that each full charging or full discharging of respective electrolytes stored in all storage tanks in the first flow battery string are scheduled to occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

20. The flow battery system of claim 1, wherein the controller controls the sequence for a charging or discharging, according to the selected mode, of the first electrolyte between the first storage tank and an empty tank to occur before a charging or discharging, according to the selected mode, of the second electrolyte between the second storage tank and the empty tank, so that the first electrolyte from the first storage tank having been charged or discharged, according to the selected mode, by the first battery stack is initially returned to the empty tank and ultimately returned back to the first storage tank and the second electrolyte from the second storage tank having been charged or discharged, according to the selected mode, by the first battery stack is subsequently initially returned to the empty tank and ultimately returned back to the second storage tank.

21. The flow battery system of claim 1, wherein the first battery stack including the first half cell, first feed system, and first return system are all parts of a first flow battery string of the flow battery system that performs a first charging or first discharging, and the flow battery system further comprises a separate and distinct second flow battery string including:
a second battery stack including a second half-cell configured to charge and/or discharge the positive and negative liquid electrolyte;
a second feed system to provide electrolyte to the first battery stack, including at least a third storage tank storing third electrolyte having a third state of charge (SOC) and a fourth storage tank storing fourth electrolyte having a fourth SOC; and
a second return system to return one of the positive electrolyte or negative liquid electrolyte from the second half-cell of the second battery stack to one of the third storage tank and the fourth storage tank with a higher SOC during a charging of the third or fourth electrolytes and with a lower SOC during a discharging of the third or fourth electrolytes,
wherein the controller controls a defined other sequence for accordingly charging or discharging the third electrolyte before charging or discharging the fourth electrolyte, based on the selected mode.

22. The flow battery system of claim 21, wherein the controller controls the sequence so that the first electrolyte and the second electrolyte are each provided to the first battery stack with differing flow rates that respectively depend on a determined SOC level of the first SOC and determined SOC level of the second SOC and the controller controls the other sequence so that the third electrolyte and the fourth electrolyte are each provided to the second battery stack with differing flow rates that respectively depend on a determined SOC level of the third SOC and determined SOC level of the fourth SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

23. The flow battery system of claim 22, wherein the determined high SOC level is about 80% SOC and the determined low SOC level is about 20% SOC.

24. The flow battery system of claim 22, wherein the determined high SOC level and/or the determined low SOC level respectively are controlled to change for the first flow battery string based on a determined number of passes of a full volume of the first or second storage tanks required to transit through the first battery stack to increase the respective first SOC or second SOC to the determined high SOC level or required to transit through the first battery stack to decrease the respective first SOC or second SOC to the determined low SOC level, and wherein the determined high SOC level and/or the determined low SOC level respectively are controlled to change for the second flow battery string based on a determined number of passes of a full volume of the third or fourth storage tanks required to transit through the second battery stack to increase the respective third SOC or fourth SOC to the determined high SOC level or required to transit through the second battery stack to decrease the respective third SOC or fourth SOC to the determined low SOC level.

25. The flow battery system of claim 22, wherein the determined high SOC level and/or the low SOC level for the first flow battery string are respectively controlled to change based on a determined amount of osmotic water transfer between the first half-cell and another half-cell of the first flow battery string and/or determined temperature of the first electrolyte and/or the second electrolyte, and wherein the determined high SOC level and/or the low SOC level for the second flow battery string are respectively controlled to change based on a determined amount of osmotic water transfer between the second half-cell and another half-cell of the second flow battery string and/or determined temperature of the third electrolyte and/or the fourth electrolyte.

26. The flow battery system of claim 22, wherein the controller controls a first point in time to implement the sequence for controlling the first electrolyte from the first storage tank to be charged or discharged, according to the selected mode, to be different from a second point in time when the other sequence is implemented controlling the third electrolyte from the third storage tank, so that full charging or full discharging of differing electrolytes in the first flow battery string occur at different times than full charging or full discharging of differing electrolytes in the second flow battery string.

27. The flow battery system of claim 26, wherein the controller controls the differing flow rates for the first flow battery string to be selectively different from differing flow rates for the second flow battery string implementing the other sequence.

28. The flow battery system of claim 27, wherein the controller controls the differing flow rates for the first flow battery string to be selectively different from the differing flow rates for the second flow battery string so that each full charging or full discharging of respective electrolytes stored in all storage tanks in the first flow battery string are scheduled to occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

29. The flow battery system of claim 21, wherein the controller controls the sequence so as to control the first electrolyte from the first storage tank to be charged or discharged, according to the selected mode, after being returned from the first battery stack to the first storage tank, so as to mix charged first electrolytes existing in the first storage tank with differently charged first electrolytes returned to the first storage tank from the first battery stack, and the controller controls the other sequence so as to control the third electrolyte from the third storage tank to be charged or discharged, according to the selected mode, after being returned from the second battery stack to the third storage tank, so as to mix charged third electrolytes existing in the third storage tank with differently charged third electrolytes returned to the third storage tank from the second battery stack.

30. The flow battery system of claim 21, wherein the controller controls the sequence for a charging or discharging, according to the selected mode, of the first electrolyte between the first storage tank and an empty tank of the first flow battery string to occur before a charging or discharging, according to the selected mode, of the second electrolyte between the second storage tank and the first storage tank, so that the first electrolyte from the first storage tank having been charged or discharged, according to the selected mode, by the first battery stack is returned to the empty tank and the second electrolyte from the second storage tank having been charged or discharged, according to the selected mode, by the first battery stack is returned to the first storage tank, and the controller controls the other sequence for a charging or discharging, according to the selected mode, of the third electrolyte between the third storage tank and an empty tank of the second flow battery string to occur before a charging or discharging, according to the selected mode, of the fourth electrolyte between the fourth storage tank and the third storage tank, so that the third electrolyte from the third storage tank having been charged or discharged, according to the selected mode, by the second battery stack is returned to the empty tank of the second battery flow string and the fourth electrolyte from the fourth storage tank having been charged or discharged, according to the selected mode, by the second battery stack is returned to the third storage tank.

31. The flow battery system of claim 21, wherein the controller controls the sequence for a charging or discharging, according to the selected mode, of the first electrolyte between the first storage tank and an empty tank of the first flow battery string to occur before a charging or discharging, according to the selected mode, of the second electrolyte between the second storage tank and the empty tank of the first flow battery string, so that the first electrolyte from the first storage tank having been charged or discharged, according to the selected mode, by the first battery stack is initially returned to the empty tank and ultimately returned back to the first storage tank and the second electrolyte from the second storage tank having been charged or discharged, according to the selected mode, by the first battery stack is subsequently initially returned to the empty tank of the first battery string and ultimately returned back to the second storage tank, and the controller controls the other sequence for a charging or discharging, according to the selected mode, of the third electrolyte between the third storage tank and an empty tank of the second flow battery string to occur before a charging or discharging, according to the selected mode, of the fourth electrolyte between the fourth storage tank and the empty tank of the second flow battery string, so that the third electrolyte from the third storage tank having been charged or discharged, according to the selected mode, by the second battery stack is initially returned to the empty tank of the second flow battery string and ultimately returned back to the third storage tank and the fourth electrolyte from the fourth storage tank having been charged or discharged, according to the selected mode, by the second battery stack is subsequently initially returned to the empty tank of the second flow battery string and ultimately returned back to the fourth storage tank.

32. The flow battery system of claim 1, further comprising one or more pulsation dampers to absorb large changes in controlled flow rates caused by a rapid changing between a high flow rate and a low flow rate upon at least one of: a changing of the selected mode before all electrolytes have been fully charged or discharged; a suspension of a conversion of the first electrolyte, from the first storage tank, from a high SOC to a low SOC and starting of a conversion of the second electrolyte, from the second storage tank, from the high SOC to the low SOC while the conversion of the first electrolyte from the high SOC to the low SOC is suspended, based on the sequence; and a suspension of a conversion of the first electrolyte, from the first storage tank, from the low SOC to the high SOC and starting of a conversion of the second electrolyte, from the second storage tank, from the low SOC to the high SOC while the conversion of the first electrolyte from the low SOC to the high SOC is suspended, based on the sequence.

33. The flow battery system of claim 1, wherein the first electrolyte, from the first storage tank, is chosen by the controller for discharging based on a determination that the first electrolyte has a higher initial SOC than the second electrolyte and/or wherein the first electrolyte, from the first storage tank, is chosen by the controller for charging based on a determination that the first electrolyte has a lower initial SOC than the second electrolyte.

34. The flow battery system of claim 1, wherein the controller implements the sequence based upon a predetermined algorithm and an applying of determined factors to the predetermined algorithm, with the determined factors including a measured height of electrolytes in one or more storage tanks on at least one of a positive and negative side of the flow battery system and measured SOC's for electrolytes stored in one or more storage tanks on at least one of the positive and negative side of the flow battery system, so as to modify the schedule for sequencing each charging and/or discharging of electrolytes respectively included in each storage tank on at least one of the positive and negative side of the flow battery system.

35. The flow battery system of claim 1, wherein the controller implements a respective positive sequence for a positive side of the flow battery system and implements a negative sequence for a negative side of the flow battery system, and selectively controls the positive sequence to operate differently from the negative sequence.

36. The flow battery system of claim 1, wherein the flow battery system is a vanadium redox flow battery system.

37. A flow battery control method for controlling a flow battery system having at least a first flow battery string that includes a first storage tank initially storing a first electrolyte with a first state of charge (SOC), a second storage tank initially storing a second electrolyte with a second SOC, and a first battery stack that includes a first half-cell configured to charge and/or discharge a positive or negative liquid electrolyte provided from the first and second storage tanks, the method comprising:
controlling a defined sequence for a selected mode of one of charging or discharging of the first and second electrolytes to charge or discharge the first electrolyte before charging or discharging the second electrolyte, based on the selected mode, such that electrolytes returned from the first battery stack are returned with a higher SOC when the selected mode indicates that the first flow battery string is in a charging mode and electrolytes returned from the first battery stack are returned with a lower SOC when the selected mode indicates that the first flow battery string is in a discharging mode.

38. The flow battery control method of claim 37, further comprising controlling the sequence so as to control the first electrolyte from the first storage tank to be charged or discharged, according to the selected mode, after being returned from the first battery stack to the first storage tank, so as to mix charged first electrolytes existing in the first storage tank with differently charged first electrolytes returned to the first storage tank from the first battery stack.

39. The flow battery control method of claim 38, further comprising controlling the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

40. The flow battery control method of claim 39, wherein the determined high SOC level is about 80% SOC and the determined low SOC level is about 20% SOC.

41. The flow battery control method of claim 39, further comprising respectively controlling the determined high SOC level and/or the determined low SOC level to change based on a determined number of passes of a full volume of the first or second storage tanks required to transit through the first battery stack to increase the respective first SOC or second SOC to the determined high SOC level or to decrease the respective first SOC or second SOC to the determined low SOC level.

42. The flow battery control method of claim 39, further comprising respectively controlling the determined high SOC level and/or the determined low SOC level to change based on a determined amount of osmotic water transfer between the first half-cell and another half-cell and/or determined temperature of the first electrolyte and/or the second electrolyte.

43. The flow battery control method of claim 39, further comprising controlling a first point in time to implement the sequence controlling the first electrolyte from the first storage tank to be charged or discharged, according to the selected mode, to be different from a second point in time when an other sequence is implemented controlling a first other electrolyte from a first other storage tank in a second flow battery string, different from the first flow battery string, to be charged or discharged according to the selected mode, so that full charging or full discharging of respective electrolytes from differing storage tanks in the first flow battery string occur at different times than full charging or full discharging of respective electrolytes from differing storage tanks in the second flow battery string.

44. The flow battery control method of claim 43, further comprising controlling the differing flow rates for the first flow battery string to be selectively different from differing flow rates for the second flow battery string implementing the other sequence.

45. The flow battery control method of claim 44, further comprising controlling the differing flow rates for the first flow battery string to be selectively different from the differing flow rates for the second flow battery string so that each full charging or full discharging of respective electrolytes stored in all storage tanks in the first flow battery string occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

46. The flow battery control method of claim 37, further comprising controlling the sequence for a charging or discharging, according to the selected mode, of the first electrolyte between the first storage tank and an empty tank to occur before a charging or discharging, according to the selected mode, of the second electrolyte between the second storage tank and the first storage tank, so that the first electrolyte from the first storage tank having been charged or discharged, according to the selected mode, by the first battery stack is returned to the empty tank and the second electrolyte from the second storage tank having been charged or discharged, according to the selected mode, by the first battery stack is returned to the first storage tank.

47. The flow battery control method of claim 46, further comprising controlling the sequence so that when the charging or the discharging of the first electrolyte is complete the empty tank becomes full with the first electrolyte after having been fully charged or discharged by the first battery stack and then the second electrolyte stored in the second storage tank is charged or discharged by providing the second electrolyte from the second storage tank to the first battery stack and returned to the first storage tank after having been fully charged or discharged by the first battery stack until the second storage tank is empty and the first storage tank is full of the fully charged or discharged second electrolyte.

48. The flow battery control method of claim 46, further comprising controlling the sequence so that the first electrolyte and the second electrolyte are each provided to the first battery stack with differing flow rates that respectively depend on a determined SOC level of the first SOC and determined SOC level of the second SOC, with a fully charged status of a charged electrolyte being when an SOC level of the charged electrolyte meets a determined high SOC level and a fully discharged status of a discharged electrolyte being when an SOC level of the discharged electrolyte meets a determined low SOC level.

49. The flow battery control method of claim 48, wherein the determined high SOC level is about 80% SOC and the determined low SOC level is about 20% SOC.

50. The flow battery control method of claim 48, further comprising respectively controlling the determined high SOC level and/or the determined low SOC level to change based on a determined number of passes of a full volume of the first or second storage tanks required to transit through the first battery stack to increase the respective first SOC or second SOC to the determined high SOC level or to decrease the respective first SOC or second SOC to the determined low SOC level.

51. The flow battery control method of claim 48, further comprising respectively controlling the determined high SOC level and/or the determined low SOC level to change based on a determined amount of osmotic water transfer between the first half-cell and another half-cell and/or determined temperature of the first electrolyte and/or the second electrolyte.

52. The flow battery control method of claim 48, further comprising controlling a first point in time to implement the sequence for controlling the first electrolyte from the first storage tank to be charged or discharged, according to the selected mode, to be different from a second point in time when an other sequence is implemented controlling a first other electrolyte from a first other storage tank in a second flow battery string, different from the first flow battery string, to be charged or discharged according to the selected mode, so that full charging or full discharging respective electrolytes from differing storage tanks in the first flow battery string occur at different times than full charging or full discharging of respective electrolyte from differing storage tanks in the second flow battery string.

53. The flow battery control method of claim 52, further comprising controlling the differing flow rates for the first flow battery string to be selectively different from differing flow rates for the second flow battery string implementing the other sequence.

54. The flow battery control method of claim 53, further comprising controlling the differing flow rates for the first flow battery string to be selectively different from the differing flow rates for the second flow battery string so that each full charging or full discharging of respective electrolytes stored in all storage tanks in the first flow battery string are scheduled to occur at different times than each of full charging or full discharging of respective electrolytes stored in all storage tanks in the second flow battery string, except when both of all electrolytes in the first flow battery string are scheduled to be fully charged or discharged and all electrolytes in the second flow battery string are scheduled to be fully charged or discharged, based on the selected mode, so scheduled completion of all charging or discharging for the first flow battery string is scheduled to occur at a same time as a scheduled completion of all charging or discharging for the second flow battery string.

55. The flow battery control method of claim 37, further comprising controlling the sequence for a charging or discharging, according to the selected mode, of the first electrolyte between the first storage tank and an empty tank to occur before a charging or discharging, according to the selected mode, of the second electrolyte between the second storage tank and the empty tank, so that the first electrolyte from the first storage tank having been charged or discharged, according to the selected mode, by the first battery stack is initially returned to the empty tank and ultimately returned back to the first storage tank and the second electrolyte from the second storage tank having been charged or discharged, according to the selected mode, by the first battery stack is subsequently initially returned to the empty tank and ultimately returned back to the second storage tank.

56. The flow battery control method of claim 37, further comprising, using one or more pulsation dampers in the first flow battery string, absorbing large changes in controlled flow rates caused by a rapid changing between a high flow rate and a low flow rate upon at least one of: a changing of the selected mode before all electrolytes have been fully charged or discharged; a suspension of a conversion of the first electrolyte, from the first storage tank, from a high SOC to a low SOC and starting of a conversion of the second electrolyte, from the second storage tank, from the high SOC to the low SOC while the conversion of the first electrolyte from the high SOC to the low SOC is suspended, based on the sequence; and a suspension of a conversion of the first electrolyte, from the first storage tank, from the low SOC to the high SOC and starting of a conversion of the second electrolyte, from the second storage tank, from the low SOC to the high SOC while the conversion of the first electrolyte from the low SOC to the high SOC is suspended, based on the sequence.

57. The flow battery control method of claim 37, further comprising choosing the first electrolyte, from the first storage tank, for discharging based on a determination that the first electrolyte has a higher initial SOC than the second electrolyte and/or choosing the first electrolyte, from the first storage tank, for charging based on a determination that the first electrolyte has a lower initial SOC than the second electrolyte.

58. The flow battery control method of claim 37, further comprising respectively implementing the sequence based upon a predetermined algorithm and applying determined factors to the predetermined algorithm, with the determined factors including a measured height of electrolytes in one or more storage tanks on at least one of a positive and negative side of the flow battery system and measured SOC's for electrolytes stored in one or more storage tanks on at least one of the positive and negative side of the flow battery system, so as to modify the schedule for sequencing each charging and/or discharging of electrolytes respectively included in each storage tank on at least one of the positive and negative side of the flow battery system.

59. The flow battery control method of claim 37, further comprising implementing a respective positive sequence for a positive side of the flow battery system and implementing a negative sequence for a negative side of the flow battery system, and selectively controlling the positive sequence to operate differently from the negative sequence.

60. The flow battery control method of claim 37, wherein the flow battery system is a vanadium redox flow battery system.
